(19) United States
(12) Patent Application Publication
(10) Pub. No.: US 2015/0376554 A1
(43) Pub. Date: Dec. 31, 2015

(54) Industrial and Institutional Laundering Using Multi-Enzyme Compositions

(71) Applicant: NOVOZYMES A/S, Bagsvaerd (DK)

(72) Inventor: Christian Ausig Christensen, Hellerup (DK)

(21) Appl. No.: 14/765,676

(22) PCT Filed: Feb. 11, 2014
(86) PCT No.: PCT/EP2014/052616

§ 371 Date: Aug. 4, 2015

Related U.S. Application Data
(60) Provisional application No. 61/764,677, filed on Feb. 14, 2013.

(30) Foreign Application Priority Data
Feb. 14, 2013 (EP) 13155192.1

(51) Int. Cl. C11D 3/386; C11D 11/00; D06F 35/00

(52) U.S. Cl. CPC C11D 3/386; D06F 35/005; C11D 3/38627; C11D 3/38645; C11D 3/38636; C11D 11/0017

(57) ABSTRACT

The present invention relates to the cleaning or laundering of fabrics and textiles whereby enzymes replace some of the surfactants, in particular in industrial applications.

### FIELD OF THE INVENTION

The present invention relates to the cleaning or laundering of fabrics and textiles whereby enzymes replace some of the detergent ingredients, in particular in industrial and automatized institutional applications.

### BACKGROUND OF THE INVENTION

The industrial and institutional laundering of fabrics and textiles has traditionally relied on the use of large amounts of strong alkalis (e.g. sodium hydroxide and potassium hydroxide), builders and surfactants at high wash temperatures to obtain good cleaning results. However, surfactants and builders are oil based products and therefore their price is dependent on the price of crude oil. Any increase in the oil price thus results in higher prices of surfactants and builders, and since industrial washing companies often have fixed price contracts with customers, this negatively affects a company's profitability. Further, extensive use of strong alkalis and chlorine bleach has a negative influence on the textile lifetime. This also influences the profitability of the industrial laundry, since they often own and rent out the textile they are washing. From an environmental perspective, reducing the amount of alkalis, chlorine, builders and surfactants is also beneficial as fewer chemicals are used resulting in less waste water and/or a lower COD in the waste water. Further to this, a low COD content in waste water is in some regions a demand to be allowed to release the waste water into the municipal waste water system.

Since industrial and institutional washing is normally carried out at high temperature, any reduction in the wash temperature will benefit both the industrial washing company and/or the institution (a hotel, a nursing home, etc.) by reducing energy bills and the environment. Furthermore, the industrial washing company can also benefit from improved capacity and productivity if the wash time can be shortened.

Thus there is a need to reduce the use of alkalis, chlorine, surfactants and builders in industrial and institutional washing as well as reduce the temperature of the main wash and to shorten the overall wash time whilst maintaining or even improving the wash performance.

### SUMMARY OF THE INVENTION

The invention relates to an improved method for industrial or institutional cleaning or laundering of textiles and/or fabrics comprising the steps:
(i) placing the fabrics/textile in the washing machine;
(ii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;
(iii) optionally washing the fabrics/textile in the wash liquor;
(iv) adding a multi-enzyme composition during step (v) as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
(v) washing the fabrics/textile in the wash liquor;
(vi) optionally adding to the wash liquor one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
(vii) draining the wash liquor;
(viii) optionally repeating the wash cycle of steps (ii) to (vii) and draining the remaining wash liquor; and
(ix) rinsing and optionally drying the fabrics/textiles,

with the proviso that:
the pH of the wash liquor in step (ii) is in the range of 8-10.5 when only one wash cycle of steps (ii) to step (vii) is performed;
   the pH of the wash liquor of step (ii) is in the range of 8-10.5 in at least one of the wash cycles when the wash cycle is repeated under step (viii); and
   bleaching systems comprising chlorine or wash liquor comprising chlorine are not used in steps (ii) to (v) in at least one of the wash cycles when the wash cycle is repeated under step (viii).

The invention further concerns an industrial or institutional cleaning or laundering method for the cleaning or laundering of textiles and/or fabrics comprising the steps:

(i) placing the fabrics/textile in the washing machine;

(ii) adding a multi-enzyme composition as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;

(iii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;

(iv) washing the fabrics/textile in the wash liquor;

(v) optionally adding one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;

(vi) draining the wash liquor;

(vii) optionally repeating the wash cycle of steps (ii) to (vi); and

(viii) rinsing and optionally drying the fabrics/textiles;

with the proviso that:

the pH of the wash liquor in step (iii) is in the range of 8-10.5 when only one wash cycle of steps (ii) to step (vi) is performed;

the pH of the wash liquor of step (iii) is in the range of 8-10.5 in at least one of the wash cycles when the wash cycle is repeated under step (viii); and

bleaching systems comprising chlorine or wash liquor comprising chlorine are not used in steps (ii) to (v) in at least one of the wash cycles when the wash cycle is repeated under step (viii).

The invention further concerns the use of a multi-enzyme composition for improving wash performance, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.

The invention also relates to the use of a multi-enzyme composition for reducing the number of re-washes and for increasing the life-time of a textile.

### BRIEF DESCRIPTION OF THE FIGURES

FIGS. 1 and 2 show the wash effect of a milder wash program containing a multi-enzyme composition compared to a normal wash program on 10 swatches.

### DEFINITIONS

COD: Chemical Oxygen Demand—a measure of the amount of organic compounds in wastewater.

Colour clarification: During washing and wearing loose or broken fibers can accumulate on the surface of the fabrics. One consequence can be that the colours of the fabric appear less bright or less intense because of the surface contaminations. Removal of the loose or broken fibers from the textile will partly restore the original colours and looks of the textile. By the term “colour clarification”, as used herein, is meant the partial restoration of the initial colours of textile.

Detergent components: the term “detergent components” is defined herein to mean the types of chemicals which can be used in detergent compositions. Examples of detergent components are alkalis, surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants and solubilizers.

Detergent composition: the term “detergent composition” refers to compositions that find use in the removal of undesired compounds from items to be cleaned, such as textiles and fabrics. The terms encompass any materials/compounds selected for industrial and institutional washing applications and the form of the product (e.g., liquid, powder, granulate, emulsion, slurry). In addition to the multi-enzyme composition, the detergent composition contains components such as alkalis, surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants, and solubilizers.

Enzyme detergency benefit: The term “enzyme detergency benefit” is defined herein as the advantageous effect one or more enzymes may add to a detergent compared to the same detergent without the enzyme(s). Important detergency benefits which can be provided by enzymes are stain removal with no or very little visible soils after washing and or cleaning, prevention or reduction of redeposition of soils released in the washing process an effect that also is termed anti-redeposition, restoring fully or partly the whiteness of textiles, which originally were white but after repeated use and wash have obtained a greyish or yellowish appearance an effect that also is termed whitening. Textile care benefits, which are not directly related to catalytic stain removal or prevention of redeposition of soils are also important for enzyme detergency benefits. Examples of such textile care benefits are prevention or reduction of dye transfer from one fabric to another fabric or another part of the same fabric an effect that is also termed dye transfer inhibition or anti-backstaining, removal of protruding or broken fibers from a fabric surface to decrease pilling tendencies or remove already existing pills or fuzz an effect that also is termed anti-pilling, improvement of the fabric-softness, colour clarification of the fabric and removal of particulate soils which are trapped in the fibers of the fabric or garment. Enzymatic bleaching is a further enzyme detergency benefit where the catalytic activity generally is used to catalyse the formation of bleaching component such as hydrogen peroxide or other peroxides.

Fully formulated: The term “fully formulated” is defined herein to mean that the detergent composition contains all of the required detergent and enzyme components to wash the textile/fabric and that the fully formulated detergent composition only needs to be added to the wash cycle for the cleaning process to begin.

Institutional: The term “institutional” is defined herein to mean On Premise Laundries

(OPL) large enough to be running their washing process similar to an industrial laundry using automatic dosing of several partially formulated detergent compositions to their washing machine(s) as opposed to those small OPL's manually dosing a single fully formulated detergent composition similar to a household situation.

Multi-enzyme composition: The term “multi-enzyme composition” is defined herein to mean a composition comprising two or more different types of enzymes having a wash effect in laundry. Examples of wash effects in laundry can be for example enzymes that are known to remove certain stains, enzymes that are known to have a anti re-deposition effect (also known as anti-greying) or enzymes that remove yellowing in laundry.

Partially formulated: The term “partially formulated” is defined herein to mean a detergent composition that does not contain all of the required detergent and/or enzyme components to wash the textile/fabric. A partially formulated detergent composition may lack the multi-enzyme composition or one or more alkalis, surfactants, builders or other detergent components which is required for the cleaning process to begin. A fully formulated detergent composition may be prepared in the wash cycle by adding two or more partially formulated detergent compositions together with the multi-enzyme composition to the wash cycle.

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, ramie, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fibre (e.g. polyamide fibre, acrylic fibre, polyester fibre, polyvinyl alcohol fibre, polyvinyl chloride fibre, polyurethane fibre, polyurea fibre, aramid fibre), and/or cellulose-containing fibre (e.g. rayon/viscose, ramie, flax/linen, jute, cellulose acetate fibre, lyocell). Fabric may be conventional washable laundry, for example stained household laundry. When the term fabric or garment is used it is intended to include the broader term textiles as well.

Wash cycle: The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

Wash liquor: The term “wash liquor” is defined herein as the solution or mixture of water and detergents optionally including the multi-enzyme composition used for laundering textiles.

Wash performance: The term “wash performance” is defined herein as the ability of a detergent composition to remove stains present on a textile to be cleaned during washing. The wash performance may be quantified by measuring the so-called remission value (REM) as defined in the Full Scale Wash assay. See also the wash performance test in Example 1.

Wash time: The term “wash time” is defined herein as the time it takes for the entire washing process; i.e. the time for the wash cycle(s) and rinse cycle(s) together.

Whiteness: The term “Whiteness” is defined herein as a broad term with different meanings in different regions and for different customers. Loss of whiteness can e.g. be due to greying, yellowing, or removal of optical brighteners/hueing agents. Greying and yellowing can be due to soil redeposition, body soils, colouring from e.g. iron and copper ions or dye transfer. Whiteness might include one or several issues from the list below: colorant or dye effects; incomplete stain removal (e.g. body soils, sebum etc.); re-deposition (greying, yellowing or other discolouration's of the object) (removed soils re-associates with other part of textile, soiled or unsoiled); chemical changes in textile during application; and clarification or brightening of colours.

### Method of the Invention

The cleaning or laundering of textiles and/or fabrics, in particular industrial and institutional laundering of textiles and/or fabrics, wherein the detergent composition is not fully formulated meaning that the individual detergent components can e.g. be added in separately or as a partially formulated composition. For example, the multi-enzyme composition may be added as a powder, granulate, slurry or solution. Alternatively, the multi-enzyme composition may be added together with one or more detergent components such as alkali, surfactants, hydrotropes, builders and co-builders, bleaching systems, polymers, fabric hueing agents and/or adjunct materials or any mixture thereof. The multi-enzyme composition may be added one or several times, such as 1, 2, 3, 4 or 5 times, during each wash cycle, such as at the beginning of the wash cycle, immediately after placing the textiles and/or fabrics into the washing machine, or during any stage of the wash cycle. It is not necessary for the multi-enzyme composition to be added during each wash cycle, but the multi-enzyme composition is added during at least one wash cycle. The detergent components may be added one or several times, such as 1, 2, 3, 4 or 5 times, during each wash cycle optionally together with the multi-enzyme composition during any stage of the wash cycle.

The invention is described as comprising the addition of a multi-enzyme composition comprising two or more enzymes. However, the invention is not limited to the addition of all enzymes in one composition. The invention also contemplates the addition of the enzymes to the wash liquor in two or more separate compositions, and that each individual composition may be together with one or more detergent components or that the enzyme or enzymes are part of one or more separate compositions. In one embodiment, the protease is added in a separate composition, such as together with one or more detergent components, to the other enzymes since this has the benefit that the other enzymes will have a longer shelf life.

Therefore the invention relates to an industrial or institutional cleaning or laundering method for the cleaning or laundering of textiles and/or fabrics comprising the steps:
(i) placing the fabrics/textile in the washing machine;
(ii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;
(iii) optionally washing the fabrics/textile in the wash liquor;
(iv) adding a multi-enzyme composition during step (v) as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
(v) washing the fabrics/textile in the wash liquor;
(vi) optionally adding to the wash liquor one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
(vii) draining the wash liquor;
(viii) optionally repeating the wash cycle of steps (ii) to (vii) and draining the remaining wash liquor; and
(ix) rinsing and optionally drying the fabrics/textiles,

with the proviso that:
the pH of the wash liquor in step (ii) is in the range of 8-10.5 when only one wash cycle of steps (ii) to step (vii) is performed;
   the pH of the wash liquor of step (ii) is in the range of 8-10.5 in at least one of the wash cycles when the wash cycle is repeated under step (viii); and
   bleaching systems comprising chlorine or wash liquor comprising chlorine are not used in steps (ii) to (v) in at least one of the wash cycles when the wash cycle is repeated under step (viii).

In one embodiment of the invention the wash liqueur in step (ii) is provided by dissolving surfactants, alkalis and or carbonate in water. In one embodiment a washing step is carried out between step (i) and step (ii), wherein the pH of the wash liquor is in the range of 8-13, such as 10-13.

Alternatively, the invention relates to an industrial cleaning or laundering method for the cleaning or laundering of textiles and/or fabrics comprising the steps:

(i) placing the fabrics/textile in the washing machine;

(ii) adding a multi-enzyme composition as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;

(iii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;

(iv) washing the fabrics/textile in the wash liquor;

(v) optionally adding one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;

(vi) draining the wash liquor;

(vii) optionally repeating the wash cycle of steps (ii) to (vi); and

(viii) rinsing and optionally drying the fabrics/textiles;

with the proviso that:

the pH of the wash liquor in step (iii) is in the range of 8-10.5 when only one wash cycle of steps (ii) to step (vi) is performed;

the pH of the wash liquor of step (iii) is in the range of 8-10.5 in at least one of the wash cycles when the wash cycle is repeated under step (viii); and

bleaching systems comprising chlorine or wash liquor comprising chlorine are not used in steps (ii) to (v) in at least one of the wash cycles when the wash cycle is repeated under step (viii).

In one embodiment of the invention the wash liqueur in step (iii) is provided by dissolving surfactants, alkalis and/or carbonate in water.

In one embodiment a washing step is carried out between step (i) and step (ii), wherein the pH of the wash liquor is in the range of 8-13, such as 10-13.

For industrial and institutional laundering large batch washing machines (washer extractors) or tunnel washing machines (continues batch washers) are used. They can be operated by a certified washer operator. The washer operator loads and unloads the washer (for a tunnel washer this is an automatized process), and decides which chemicals to add to the washing machine as well as the temperature, the number of wash cycles and their duration—typically by choosing one of several preprogrammed washing programs. The various detergent components used for the washing process are added separately or as partially formulated detergent compositions and therefore allows the operator to dose these components separately. Industrial and institutional washing processes are usually carried out in very harsh environment, where strong alkali, strong acids and strong bleach are used during the process. This is bad for the environment and the textile life time. However, the customers using industrial and institutional washing expect their laundry to be completely clean and without stains after wash. Therefore, there has been a prejudice against changing the industrial washing processes and omitting the use of strong acids, bleach and alkalis.

The inventor of the present invention has found that by use of a multi-enzyme composition of the invention the use of strong alkalis during the whole washing process can be significantly reduced or omitted. During industrial and institutional washing the addition of the strong alkalis and acids can be made several times during the washing process. The inventor has found that adding enough alkali to raise the pH of the washing liquor to be in the range of 8 to 10.5 during part of the washing process is sufficient for cleaning the laundry textile when a multi-enzyme composition is used. The pH of the wash liquor is in the range of 7-10.5, in the range of 8.0-10.5, in the range of 8.5-9.5, in the range of 9-9.5, in the range of 9-11, in the range of 9.5-10.5, in the range of 10-11 or in the range of 10.5-11.

If only one wash cycle is completed the pH of the wash liquor may be in the range of 7-10.5, in the range of 8-10.5, in the range of 8.5-9.5 or in the range of 9-9.5 or in the range of 9.5-10.5.

If more than one wash cycle is completed the pH of the wash liquor may be in the range of 7-10.5, in the range of 8-10.5, in the range of 8.5-9.5 or in the range of 9-9.5 or in the range of 9.5-10.5 in at least one of the wash cycles and the pH of the wash liquor during a second or third wash cycle may be in the range of 9-11, in the range of 10-11, in the range of 11-12, in the range of 12-13 or in the range of 11.5-12.5.

The multi-enzyme composition is described below.

An embodiment of the invention is that the multi-enzyme composition gives improved cleaning benefits such as improved wash performance and/or enzyme detergency benefits. A further embodiment of the invention is that the multi-enzyme composition gives an improved wash performance on corn starch and pigment stains, cocoa/oat flake stains, salad dressing stains and/or chocolate pudding stains. An additional embodiment of the invention is that the multi-enzyme composition gives an enzyme detergency benefit on CFT C-S-28 corn starch and pigment stains, CFT KC-H097 cocoa/oat flake stains, CFT C-S-06 salad dressing stains and/or EMPA 165 chocolate pudding stains.

Another embodiment of the invention is that the amount of detergent components, such as alkalis (e.g. sodium hydroxide and/or potassium hydroxide), surfactants, hydrotropes, builders and co-builders, bleaching systems, polymers, fabric hueing agents and adjunct materials that are used in the wash cycle can be reduced. A further embodiment is that the amount of detergent components, such as alkalis, surfactants, hydrotropes, builders and co-builders, bleaching systems, polymers, fabric hueing agents and adjunct materials that are used in the wash cycle can be reduced whilst at the same time obtaining improved cleaning benefits such as improved wash performance and/or enzyme detergency benefits.

An embodiment of the invention is the reduction in the amount of detergent components by between 5% and 95%. A preferred embodiment is the reduction in the amount of detergent components by between 10% and 80%. A more preferred embodiment is the reduction in the amount of detergent components by between 15% and 65%. An even more preferred embodiment is the reduction in the amount of detergent components by between 20% and 50%. An even more preferred embodiment is the reduction in the amount of detergent components by between 25% and 45%. A most preferred embodiment is the reduction in the amount of detergent components by between 25% and 45% whilst at the same time obtaining improved cleaning benefits such as improved wash performance and/or enzyme detergency benefits on e.g. corn starch and pigment stains, cocoa/oat flake stains, salad dressing stains and/or chocolate pudding stains.

An embodiment of the invention is the reduction in the amount of alkalis by between 5% and 95%. A preferred embodiment is the reduction in the amount of alkalis by between 10% and 80%. A more preferred embodiment is the reduction in the amount of alkalis by between 15% and 65%. An even more preferred embodiment is the reduction in the amount of alkalis by between 20% and 50%. An even more preferred embodiment is the reduction in the amount of alkalis by between 25% and 45%. A most preferred embodiment is the reduction in the amount of alkalis by between 25% and 45% whilst at the same time obtaining improved cleaning benefits such as improved wash performance and/or enzyme detergency benefits.

An embodiment of the invention is the reduction in the amount of surfactants by between 5% and 95%. A preferred embodiment is the reduction in the amount of surfactants by between 10% and 80%. A more preferred embodiment is the reduction in the amount of surfactants by between 15% and 65%. An even more preferred embodiment is the reduction in the amount of surfactants by between 20% and 50%. An even more preferred embodiment is the reduction in the amount of surfactants by between 25% and 45%. A most preferred embodiment is the reduction in the amount of surfactants by between 25% and 45% whilst at the same time obtaining improved cleaning benefits such as improved wash performance and/or enzyme detergency benefits.

An embodiment of the invention is the reduction in the amount of builders and co-builders by between 5% and 95%. A preferred embodiment is the reduction in the amount of builders and co-builders by between 10% and 80%. A more preferred embodiment is the reduction in the amount of builders and co-builders by between 15% and 65%. An even more preferred embodiment is the reduction in the amount of builders and co-builders by between 20% and 50%. An even more preferred embodiment is the reduction in the amount of builders and co-builders by between 25% and 45%. A most preferred embodiment is the reduction in the amount of builders and co-builders by between 25% and 45% whilst at the same time obtaining improved cleaning benefits such as improved wash performance and/or enzyme detergency benefits.

An embodiment of the invention is the reduction in the amount of hydrotropes by between 5% and 95%. A preferred embodiment is the reduction in the amount of hydrotropes by between 10% and 80%. A more preferred embodiment is the reduction in the amount of hydrotropes by between 15% and 65%. An even more preferred embodiment is the reduction in the amount of hydrotropes by between 20% and 50%. An even more preferred embodiment is the reduction in the amount of hydrotropes by between 25% and 45%. A most preferred embodiment is the reduction in the amount of hydrotropes by between 25% and 45% whilst at the same time obtaining improved cleaning benefits such as improved wash performance and/or enzyme detergency benefits

In order to obtain good cleaning results, the maximum wash temperature of an industrial washing machine is usually very high, such as between 65° C. and 90° C., or between 70° C. and 80° C. An embodiment of the invention is a reduction in the maximum wash temperature, such that the maximum wash temperature is between 30° C. and 60° C., such as at 30° C., 35° C., 40° C., 45° C., 50° C., 55° C. or 60° C. A further embodiment of the invention is that the maximum wash temperature is reduced by between 10° C. and 60° C., such as by 10° C., 15° C., 20° C., 25° C., 30° C., 35° C., 40° C., 45° C., 50° C., 55° C. or 60° C.

An embodiment of the invention is a reduction in the maximum wash temperature whilst at the same time obtaining improved cleaning benefits such as improved wash performance and/or enzyme detergency benefits. A preferred embodiment is a reduction in the maximum wash temperature to between 30° C. and 60° C. whilst at the same time obtaining improved cleaning benefits such as improved wash performance and/or enzyme detergency benefits on e.g. corn starch and pigment stains, cocoa/oat flake stains, salad dressing stains and/or chocolate pudding stains.

A further embodiment of the invention is a reduction in the maximum wash temperature and a reduction in the amount of detergent components by between 5% and 95% whilst at the same time obtaining improved cleaning benefits such as improved wash performance and/or enzyme detergency benefits. A preferred embodiment is a reduction in the maximum wash temperature and a reduction in the amount of detergent components by between 10% and 80%. A more preferred embodiment is a reduction in the maximum wash temperature and a reduction in the amount of detergent components by between 15% and 65%. An even more preferred embodiment is a reduction in the maximum wash temperature and a reduction in the amount of detergent components by between 20% and 50%. A most preferred embodiment is a reduction in the maximum wash temperature and a reduction in the amount of detergent components by between 25% and 45% whilst at the same time obtaining improved cleaning benefits such as improved wash performance and/or enzyme detergency benefits on e.g. corn starch and pigment stains, cocoa/oat flake stains, salad dressing stains and/or chocolate pudding stains.

An embodiment of the invention is the reduction in the washing time by between 5% and 95% whilst at the same time obtaining improved cleaning benefits such as improved wash performance and/or improved enzyme detergency. A preferred embodiment is the reduction in the washing time by between 10% and 80%. A more preferred embodiment is the reduction in the washing time by between 15% and 65%. An even more preferred embodiment is the reduction in the washing time by between 20% and 50%. A most preferred embodiment is the reduction in the washing time by between 25% and 45% whilst at the same time obtaining improved cleaning benefits such as improved wash performance and/or enzyme detergency benefits on e.g. corn starch and pigment stains, cocoa/oat flake stains, salad dressing stains and/or chocolate pudding stains.

A further embodiment of the invention is a reduction in the maximum wash temperature, a reduction in the amount of detergent components by between 5% and 95% and a reduction in the washing time by between 5% and 95% whilst at the same time obtaining improved cleaning benefits such as improved wash performance and/or enzyme detergency benefits. A preferred embodiment is a reduction in the maximum wash temperature, a reduction in the amount of detergent components by between 10% and 80% and a reduction in the washing time by between 10% and 80%. A more preferred embodiment is a reduction in the maximum wash temperature, a reduction in the amount of detergent components by between 15% and 65% and a reduction in the washing time by between 15% and 65%. An even more preferred embodiment is a reduction in the maximum wash temperature, a reduction in the amount of detergent components by between 20% and 50% and a reduction in the washing time by between 20% and 50%. A most preferred embodiment is a reduction in the maximum wash temperature, a reduction in the amount of detergent components by between 25% and 45% and a reduction in the washing time by between 25% and 45% whilst at the same time obtaining improved cleaning benefits such as improved wash performance and/or enzyme detergency benefits on e.g. corn starch and pigment stains, cocoa/oat flake stains, salad dressing stains and/or chocolate pudding stains.

An embodiment of the invention is a reduction in the number of pieces of textile/fabric which need to be re-washed, or washed more than 1 time, before the textile/fabric is clean. The rewashing of fabrics/textiles which are still soiled after first wash requires significant effort, since the still dirty fabric/textile has to be sorted from the clean fabric/textile and then a harsher wash program is often used or the fabric/textile is bleached prior to being re-washed. This re-wash procedure also causes significant wear on the fabric/textile due to the bleach and/or harsher wash conditions used.

In one embodiment, the number of pieces of textile/fabric that needs to be re-washed, or washed more than 1 time, before being clean is reduced by at least 10%, such as at least 20%, at least 30%, at least 40%, at least 50%, at least 60%, at least 70%, at least 80% or at least 90%. In a preferred embodiment the number of pieces of textile/fabric that needs to be re-washed before being clean is reduced by at least 30%. In a more preferred embodiment, the number of pieces of textile/fabric that needs to be re-washed before being clean is reduced by at least 40%.

An embodiment of the invention is that the number of pieces of textile/fabric that needs to be re-washed before being clean is reduced by at least 20% whilst at the same time there is a reduction in the maximum wash temperature, a reduction in the amount of detergent components by between 5% and 95% and/or a reduction in the washing time by between 5% and 95%. A preferred embodiment is that the number of pieces of textile/fabric that needs to be re-washed before being clean is reduced by at least 25% whilst at the same time there is a reduction in the maximum wash temperature, a reduction in the amount of detergent components by between 10% and 80% and/or a reduction in the washing time by between 10% and 80%. A more preferred embodiment is that the number of pieces of textile/fabric that needs to be re-washed before being clean is reduced by at least 30% whilst at the same time there is a reduction in the maximum wash temperature, a reduction in the amount of detergent components by between 15% and 65% and/or a reduction in the washing time by between 15% and 65%. An even more preferred embodiment is that the number of pieces of textile/fabric that needs to be re-washed before being clean is reduced by at least 35% whilst at the same time there is a reduction in the maximum wash temperature, a reduction in the amount of detergent components by between 20% and 50% and/or a reduction in the washing time by between 20% and 50%. A most preferred embodiment is that the number of pieces of textile/fabric that needs to be re-washed before being clean is reduced at least 40% whilst at the same time there is a reduction in the maximum wash temperature, a reduction in the amount of detergent components by between 25% and 45% and/or a reduction in the washing time by between 25% and 45%.

A further embodiment of the invention is that the lifespan of the textile/fabric increases. Another embodiment of the invention is a reduction in the amount of textile/fabric which is discarded due to stains that cannot be cleaned or removed. It is envisioned that said embodiments can also be specifically combined with a reduction in the number of times a textile/fabric needs to be washed before it is clean, a reduction in maximum wash temperature, a reduction in the amount of detergent components and/or a reduction in the washing time.

In one embodiment of the invention the wash liquor is only partly drained and the remainder of the wash liquor is used as wash liquor during a second or third wash cycle. The re-used wash liquor may be diluted with a new supply of water. In addition further detergent components may be added.

The bleaching system can comprise hydrogen peroxide, preformed peracids and mixtures thereof. In one embodiment of the invention the peracids may be selected from the group consisting of peroxycarboxylic acids and salts, percarbonic acids and salts, perimidic acids and salts, peroxymonosulfuric acids and salts and mixtures thereof.

In one embodiment of the invention the washing method is performed in a tunnel washer (continues batch washer).

One embodiment of the invention is the use of a multi-enzyme composition for improving wash performance, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.

The remission value is at least 2 remission units higher than when compared to a similar washing method where the maximum wash temperature is not reduced and a multi-enzyme composition is not used. The remission value may be at least 3 remission units higher, at least 4 remission units higher, at least 4 remission units higher, at least 5 remission units higher, at least 6 remission units higher, at least 7 remission units higher, at least 8 remission units higher, at least 9 remission units higher, at least 10 remission units higher, at least 11 remission units higher, at least 12 remission units higher, at least 13 remission units higher, at least 14 remission units higher, at least 15 remission units higher, at least 16 remission units higher, at least 17 remission units higher, at least 18 remission units higher, at least 19 remission units higher or at least 20 remission units higher.

In one embodiment where the multi-enzyme composition is used the wash temperature is reduced whilst at the same time obtaining equal or improved wash performance compared to the method where the temperature is not reduced and a multi-enzyme composition is not used.

After the laundry has been washed, the clean linen is dried, ironed and folded. Some items, such as towels and blankets, are put through a dryer until they are no longer damp, then sent to mechanical folders. “Wetwork” items, such as sheets, are sent through steam-powered ironers which dry, press and fold them. During these processes steam is developed and released into the environment. Depending on the laundry textile the textile may release unpleasant odors with the steam.

In one embodiment of the invention where the multi-enzyme composition is used the malodor from laundry and/or textile is reduced, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.

Industrial washing of laundry items is a laborious task. First the laundry textiles are received and sorted. Then the laundry is washed, dried, ironed or pressed. Then the clean laundry items are sent back to the customer. If a laundry item is not completely clean, e.g. a table-cloth for a restaurant, the item will be sent back for re-washing. The re-wash again includes all the steps of handling the laundry items, including possibly an extra currier shipment to the customer. Re-washing of items is therefore a very expensive cost. Further, in a re-wash typically even higher amounts of harsh chemicals, including chlorine bleach, will be used to remove the stains. The inventor has found that the used of the multi-enzyme composition reduces the number of items to be re-washed.

In one embodiment of the invention where the multi-enzyme composition is used the number of re-washes is reduced, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.

In one embodiment the number of re-washes is reduced by at least 5%, or by at least 10% or by at least 15%. In one embodiment of the invention the life-time of a textile is increased by using a multi-enzyme composition comprising two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.Multi-enzyme composition

Preferably the multi-enzyme composition comprises two or more enzymes selected among protease, amylase, such as alpha-amylase, lipase, cellulase, cutinase, acyltransferase, endoglucanase, xyloglucanase, mannanase, arabinase, galactanase, pectinase, pectate lyase, xanthanase, xanthan lyase, xylanase, chlorophylase and oxidase such as laccase and/or peroxidase.

The multi-enzyme composition may comprise of three or more enzymes, such as four or more enzymes, such as five or more enzymes, such as six or more enzymes such as seven or more enzymes. More than one enzyme may belong to the same class of enzymes, e.g. there may be 2 different proteases, 2 different amylases and/or 2 different cellulases in the multi-enzyme composition.

In one embodiment the multi-enzyme composition comprises two or more enzymes and comprises one or more proteases and one or more amylases, one or more proteases and one or more cellulases, one or more proteases and one or more lipases, one or more proteases and one or more pectinases, one or more proteases and one or more mannanases, one or more proteases and one or more xyloglucanases, one or more proteases and one or more xanthanases, one or more amylases and one or more cellulases, one or more amylases and one or more lipases, one or more amylases and one or more pectinases, one or more amylases and one or more mannanases, one or more amylases and one or more xyloglucanases, one or more amylases and one or more xanthanases, a cellulase and one or more lipases, one or more cellulases and one or more pectinases, one or more cellulases and one or more mannanases, one or more cellulases and one or more xyloglucanases, one or more cellulases and one or more xanthanases, one or more lipases and one or more pectinases, one or more lipases and one or more mannanases, one or more lipases and one or more xyloglucanases, one or more lipases and one or more xanthanases, one or more pectinases and one or more mannanases, one or more pectinases and one or more xyloglucanases, one or more pectinases and one or more xanthanases, one or more mannanases and one or more xyloglucanases, one or more mannanases and one or more xanthanases or one or more xyloglucanases and one or more xanthanases.

In another embodiment the multi-enzyme composition comprises three or more enzymes and comprises one or more proteases, one or more amylases and one or more cellulases; one or more proteases, one or more amylases and one or more lipases; one or more proteases, one or more amylases and one or more pectinases; one or more proteases, one or more amylases and one or more mannanases; one or more proteases, one or more amylases and one or more xyloglucanases; one or more proteases, one or more amylases and one or more xanthanases; one or more proteases, one or more cellulases and one or more lipases; one or more proteases, one or more cellulases and one or more pectinases; one or more proteases, one or more cellulases and one or more mannanases; one or more proteases, one or more cellulases and one or more xyloglucanases; one or more proteases one or more cellulases and one or more xanthanases; one or more proteases, one or more lipases and one or more pectinases; one or more proteases, one or more lipases and one or more mannanases; one or more proteases one or more lipases and one or more xyloglucanases; one or more proteases, one or more lipases and one or more xanthanases; one or more proteases, one or more pectinases and one or more mannanases; one or more proteases, one or more pectinases and one or more xyloglucanases; one or more proteases, one or more pectinases and one or more xanthanases; one or more proteases, one or more mannanases and one or more xyloglucanases; one or more proteases, one or more mannanases and one or more xanthanases; one or more proteases, one or more xyloglucanases and one or more xanthanases.

In a preferred embodiment the multi-enzyme composition comprises one or more proteases, one or more amylases and one or more cellulases. In a more preferred embodiment, the multi-enzyme composition comprises one or more proteases, one or more amylases, one or more cellulases and one or more lipases. In an even more preferred embodiment, the multi-enzyme composition comprises one or more proteases, one or more amylases, one or more cellulases, one or more lipases and one or more pectinases. In a most preferred embodiment, the multi-enzyme composition comprises one or more proteases, one or more amylases, one or more cellulases, one or more lipases, one or more pectinases and one or more further enzymes selected among xyloglucanases, mannanases, xanthanases, peroxidises, laccases and oxidases.

In one embodiment the multi-enzyme composition comprises two or more polypeptides selected among:

(i) one or more proteases selected from the group consisting of:
(a) a polypeptide having at least 90%, such as at least 95%, sequence identity to SEQ ID NO: 1;
(b) a polypeptide having at least 90%, such as at least 95%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90%, such as at least 95%, sequence identity to SEQ ID NO: 2; (d) a polypeptide having at least 90%, such as at least 95%, sequence identity SEQ ID NO: 2 or a variant thereof wherein the polypeptide comprises a substitution in one or more of positions: 3, 4, 99, 101, 103, 104, 159, 194, 199, 205 and/or 217; and
(e) a polypeptide having at least 90%, such as at least 95%, sequence identity SEQ ID NO: 23.

(ii) one or more amylases selected from the group consisting of:
(a) a polypeptide having at least 90%, such as at least 95%, sequence identity to SEQ ID NO: 3;
(b) a polypeptide having at least 90%, such as at least 95%, sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90%, such as at least 95%, sequence identity to SEQ ID NO: 4
(d) a polypeptide having at least 90%, such as at least 95%, sequence identity to the hybrid polypeptide of SEQ ID NO: 5
(e) a polypeptide having at least 90%, such as at least 95%, sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90%, such as at least 95%, sequence identity to SEQ ID NO: 6;
(g) a polypeptide having at least 90%, such as at least 95%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
(h) a polypeptide having at least 90%, such as at least 95%, sequence identity to SEQ ID NO: 7, SEQ ID NO: 8 or SEQ ID NO: 9;
(i) a polypeptide having at least 90%, such as at least 95%, sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184 195, 206, 243, 260, 304 and/or 476;
(j) a polypeptide having at least 90%, such as at least 95%, sequence identity to SEQ ID NO: 10;
(k) a polypeptide having at least 90%, such as at least 95%, sequence identity to SEQ ID NO: 11;
(l) a polypeptide having at least 90%, such as at least 95%, sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
(m) a polypeptide having at least 90%, such as at least 95%, sequence identity to SEQ ID NO: 12;
(n) a polypeptide having at least 90%, such as at least 95%, sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
(o) a polypeptide having at least 90%, such as at least 95%, sequence identity to SEQ ID NO: 13; and
(p) a polypeptide having at least 90%, such as at least 95%, sequence identity to SEQ ID NO: 13 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484;

(iii) one or more cellulases selected from the group consisting of:
(a) a polypeptide having at least 90%, such as at least 95%, sequence identity to the amino acid sequence of position 1 to position 773 of SEQ ID NO:14; and
(b) a polypeptide having at least 80%, such as at least 85%, such as at least 90%, such as at least 95% sequence identity to SEQ ID NO: 15; and
(c) a polypeptide having at least 80%, such as at least 85%, such as at least 90%, such as at least 95% sequence identity to SEQ ID NO: 15 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
(d) a polypeptide having at least 80%, such as at least 85%, such as at least 90%, such as at least 95% sequence identity to SEQ ID NO: 22;

(iv) one or more lipases selected from the group consisting of:
(a) a polypeptide having at least 90%, such as at least 95%, sequence identity to SEQ ID NO: 16;
(b) a polypeptide having at least 90%, such as at least 95%, sequence identity to SEQ ID NO: 16 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
(c) a polypeptide having at least 90%, such as at least 95%, sequence identity to SEQ ID NO: 16 or a variant thereof wherein the polypeptide comprises the following substitutions T231R and N233R;

(v) one or more pectate lyases selected from the group consisting of:
(a) a polypeptide having at least 80%, such as at least 85%, at least 90%, or at least 95% sequence identity to SEQ ID NO: 17; and
(b) a polypeptide having at least 80%, such as at least 85%, at least 90%, or at least 95% sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397; or

(vi) one or more mannanases selected from the group consisting of:
(a) a polypeptide having at least 80%, such as at least 85%, at least 90%, or at least 95% sequence identity to amino acids 31 to 330 of SEQ ID NO: 2 of WO 99/64619;
(b) a polypeptide having at least 80%, such as at least 85%, at least 90%, or at least 95% sequence identity to amino acids 32 to 334 of SEQ ID NO: 6 of WO 99/64619;
(c) a polypeptide having at least 80%, such as at least 85%, at least 90%, or at least 95% sequence identity to amino acids 33 to 331 of SEQ ID NO: 12 of WO 99/64619; and
(d) a polypeptide having at least 80%, such as at least 85%, at least 90%, or at least 95% sequence identity to amino acids 68 to 369 of SEQ ID NO: 16 of WO 99/64619.

In a preferred embodiment the multi-enzyme composition comprises three or more polypeptides selected among:

(i) one or more proteases selected from the group consisting of:
(a) a polypeptide having at least 90%, such as at least 95%, sequence identity to SEQ ID NO: 1;
(b) a polypeptide having at least 90%, such as at least 95%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90%, such as at least 95%, sequence identity to SEQ ID NO: 2; and
(d) a polypeptide having at least 90%, such as at least 95%, sequence identity SEQ ID NO: 2 or a variant thereof wherein the polypeptide comprises a substitution in one or more of positions: 3, 4, 99, 101, 103, 104, 159, 194, 199, 205 and/or 217;

(ii) one or more amylases selected from the group consisting of:
(a) a polypeptide having at least 90%, such as at least 95%, sequence identity to SEQ ID NO: 3;
(b) a polypeptide having at least 90%, such as at least 95%, sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90%, such as at least 95%, sequence identity to SEQ ID NO: 4
(d) a polypeptide having at least 90%, such as at least 95%, sequence identity to the hybrid polypeptide of SEQ ID NO: 5
(e) a polypeptide having at least 90%, such as at least 95%, sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90%, such as at least 95%, sequence identity to SEQ ID NO: 6;
(g) a polypeptide having at least 90%, such as at least 95%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
(h) a polypeptide having at least 90%, such as at least 95%, sequence identity to SEQ ID NO: 7, SEQ ID NO: 8 or SEQ ID NO: 9;
(i) a polypeptide having at least 90%, such as at least 95%, sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184 195, 206, 243, 260, 304 and/or 476;
(j) a polypeptide having at least 90%, such as at least 95%, sequence identity to SEQ ID NO: 10;
(k) a polypeptide having at least 90%, such as at least 95%, sequence identity to SEQ ID NO: 11;
(l) a polypeptide having at least 90%, such as at least 95%, sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
(m) a polypeptide having at least 90%, such as at least 95%, sequence identity to SEQ ID NO: 12;
(n) a polypeptide having at least 90%, such as at least 95%, sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
(o) a polypeptide having at least 90%, such as at least 95%, sequence identity to SEQ ID NO: 13; and
(p) a polypeptide having at least 90%, such as at least 95%, sequence identity to SEQ ID NO: 13 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484;

(iii) one or more cellulases selected from the group consisting of:
(a) a polypeptide having at least 90%, such as at least 95%, sequence identity to the amino acid sequence of position 1 to position 773 of SEQ ID NO:14; and
(b) a polypeptide having at least 80%, such as at least 85%, such as at least 90%, such as at least 95% sequence identity to SEQ ID NO: 15; and
(c) a polypeptide having at least 80%, such as at least 85%, such as at least 90%, such as at least 95% sequence identity to SEQ ID NO: 15 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
(d) a polypeptide having at least 80%, such as at least 85%, such as at least 90%, such as at least 95% sequence identity to SEQ ID NO: 22;

(iv) one or more lipases selected from the group consisting of:
(a) a polypeptide having at least 90%, such as at least 95%, sequence identity to SEQ ID NO: 16;
(b) a polypeptide having at least 90%, such as at least 95%, sequence identity to SEQ ID NO: 16 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
(c) a polypeptide having at least 90%, such as at least 95%, sequence identity to SEQ ID NO: 16 or a variant thereof wherein the polypeptide comprises the following substitutions T231R and N233R;

(v) one or more pectate lyases selected from the group consisting of:
(a) a polypeptide having at least 80%, such as at least 85%, at least 90%, or at least 95% sequence identity to SEQ ID NO: 17; and
(b) a polypeptide having at least 80%, such as at least 85%, at least 90%, or at least 95% sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397; or

(vi) one or more mannanases selected from the group consisting of:
(a) a polypeptide having at least 80%, such as at least 85%, at least 90%, or at least 95% sequence identity to amino acids 31 to 330 of SEQ ID NO: 2 of WO 99/64619;
(b) a polypeptide having at least 80%, such as at least 85%, at least 90%, or at least 95% sequence identity to amino acids 32 to 334 of SEQ ID NO: 6 of WO 99/64619;
(c) a polypeptide having at least 80%, such as at least 85%, at least 90%, or at least 95% sequence identity to amino acids 33 to 331 of SEQ ID NO: 12 of WO 99/64619; and
(d) a polypeptide having at least 80%, such as at least 85%, at least 90%, or at least 95% sequence identity to amino acids 68 to 369 of SEQ ID NO: 16 of WO 99/64619.

In a more preferred embodiment the multi-enzyme composition comprises four or more polypeptides selected among:

(i) one or more proteases selected from the group consisting of:
(a) a polypeptide having at least 90%, such as at least 95%, sequence identity to SEQ ID NO: 1;
(b) a polypeptide having at least 90%, such as at least 95%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90%, such as at least 95%, sequence identity to SEQ ID NO: 2; (d) a polypeptide having at least 90%, such as at least 95%, sequence identity SEQ ID NO: 2 or a variant thereof wherein the polypeptide comprises a substitution in one or more of positions: 3, 4, 99, 101, 103, 104, 159, 194, 199, 205 and/or 217; and
(e) a polypeptide having at least 90%, such as at least 95%, sequence identity SEQ ID NO: 23.

(ii) one or more amylases selected from the group consisting of:
(a) a polypeptide having at least 90%, such as at least 95%, sequence identity to SEQ ID NO: 3;
(b) a polypeptide having at least 90%, such as at least 95%, sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90%, such as at least 95%, sequence identity to SEQ ID NO: 4
(d) a polypeptide having at least 90%, such as at least 95%, sequence identity to the hybrid polypeptide of SEQ ID NO: 5
(e) a polypeptide having at least 90%, such as at least 95%, sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90%, such as at least 95%, sequence identity to SEQ ID NO: 6;
(g) a polypeptide having at least 90%, such as at least 95%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
(h) a polypeptide having at least 90%, such as at least 95%, sequence identity to SEQ ID NO: 7, SEQ ID NO: 8 or SEQ ID NO: 9;
(i) a polypeptide having at least 90%, such as at least 95%, sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184 195, 206, 243, 260, 304 and/or 476;
(j) a polypeptide having at least 90%, such as at least 95%, sequence identity to SEQ ID NO: 10;
(k) a polypeptide having at least 90%, such as at least 95%, sequence identity to SEQ ID NO: 11;
(I) a polypeptide having at least 90%, such as at least 95%, sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
(m) a polypeptide having at least 90%, such as at least 95%, sequence identity to SEQ ID NO: 12;
(n) a polypeptide having at least 90%, such as at least 95%, sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
(o) a polypeptide having at least 90%, such as at least 95%, sequence identity to SEQ ID NO: 13; and
(p) a polypeptide having at least 90%, such as at least 95%, sequence identity to SEQ ID NO: 13 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484;

(iii) one or more cellulases selected from the group consisting of:
(a) a polypeptide having at least 90%, such as at least 95%, sequence identity to the amino acid sequence of position 1 to position 773 of SEQ ID NO:14; and
(b) a polypeptide having at least 80%, such as at least 85%, such as at least 90%, such as at least 95% sequence identity to SEQ ID NO: 15; and
(c) a polypeptide having at least 80%, such as at least 85%, such as at least 90%, such as at least 95% sequence identity to SEQ ID NO: 15 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
(d) a polypeptide having at least 80%, such as at least 85%, such as at least 90%, such as at least 95% sequence identity to SEQ ID NO: 22;

(iv) one or more lipases selected from the group consisting of:
(a) a polypeptide having at least 90%, such as at least 95%, sequence identity to SEQ ID NO: 16;
(b) a polypeptide having at least 90%, such as at least 95%, sequence identity to SEQ ID NO: 16 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
(c) a polypeptide having at least 90%, such as at least 95%, sequence identity to SEQ ID NO: 16 or a variant thereof wherein the polypeptide comprises the following substitutions T231R and N233R;

(v) one or more pectate lyases selected from the group consisting of:
(a) a polypeptide having at least 80%, such as at least 85%, at least 90%, or at least 95% sequence identity to SEQ ID NO: 17; and
(b) a polypeptide having at least 80%, such as at least 85%, at least 90%, or at least 95% sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397; or

(vi) one or more mannanases selected from the group consisting of:
(a) a polypeptide having at least 80%, such as at least 85%, at least 90%, or at least 95% sequence identity to amino acids 31 to 330 of SEQ ID NO: 2 of WO 99/64619;
(b) a polypeptide having at least 80%, such as at least 85%, at least 90%, or at least 95% sequence identity to amino acids 32 to 334 of SEQ ID NO: 6 of WO 99/64619;
(c) a polypeptide having at least 80%, such as at least 85%, at least 90%, or at least 95% sequence identity to amino acids 33 to 331 of SEQ ID NO: 12 of WO 99/64619; and
(d) a polypeptide having at least 80%, such as at least 85%, at least 90%, or at least 95% sequence identity to amino acids 68 to 369 of SEQ ID NO: 16 of WO 99/64619.

In an even more preferred embodiment the multi-enzyme composition comprises five or more polypeptides selected among:

(i) one or more proteases selected from the group consisting of:
(a) a polypeptide having at least 90%, such as at least 95%, sequence identity to SEQ ID NO: 1;
(b) a polypeptide having at least 90%, such as at least 95%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90%, such as at least 95%, sequence identity to SEQ ID NO: 2; (d) a polypeptide having at least 90%, such as at least 95%, sequence identity SEQ ID NO: 2 or a variant thereof wherein the polypeptide comprises a substitution in one or more of positions: 3, 4, 99, 101, 103, 104, 159, 194, 199, 205 and/or 217; and
(e) a polypeptide having at least 90%, such as at least 95%, sequence identity SEQ ID NO: 23.

(ii) one or more amylases selected from the group consisting of:
(a) a polypeptide having at least 90%, such as at least 95%, sequence identity to SEQ ID NO: 3;
(b) a polypeptide having at least 90%, such as at least 95%, sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90%, such as at least 95%, sequence identity to SEQ ID NO: 4
(d) a polypeptide having at least 90%, such as at least 95%, sequence identity to the hybrid polypeptide of SEQ ID NO: 5
(e) a polypeptide having at least 90%, such as at least 95%, sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90%, such as at least 95%, sequence identity to SEQ ID NO: 6;
(g) a polypeptide having at least 90%, such as at least 95%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
(h) a polypeptide having at least 90%, such as at least 95%, sequence identity to SEQ ID NO: 7, SEQ ID NO: 8 or SEQ ID NO: 9;
(i) a polypeptide having at least 90%, such as at least 95%, sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184 195, 206, 243, 260, 304 and/or 476;
(j) a polypeptide having at least 90%, such as at least 95%, sequence identity to SEQ ID NO: 10;
(k) a polypeptide having at least 90%, such as at least 95%, sequence identity to SEQ ID NO: 11;
(l) a polypeptide having at least 90%, such as at least 95%, sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
(m) a polypeptide having at least 90%, such as at least 95%, sequence identity to SEQ ID NO: 12;
(n) a polypeptide having at least 90%, such as at least 95%, sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
(o) a polypeptide having at least 90%, such as at least 95%, sequence identity to SEQ ID NO: 13; and
(p) a polypeptide having at least 90%, such as at least 95%, sequence identity to SEQ ID NO: 13 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484;

(iii) one or more cellulases selected from the group consisting of:
(a) a polypeptide having at least 90%, such as at least 95%, sequence identity to the amino acid sequence of position 1 to position 773 of SEQ ID NO:14; and
(b) a polypeptide having at least 80%, such as at least 85%, such as at least 90%, such as at least 95% sequence identity to SEQ ID NO: 15; and
(c) a polypeptide having at least 80%, such as at least 85%, such as at least 90%, such as at least 95% sequence identity to SEQ ID NO: 15 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
(d) a polypeptide having at least 80%, such as at least 85%, such as at least 90%, such as at least 95% sequence identity to SEQ ID NO: 22;

(iv) one or more lipases selected from the group consisting of:
(a) a polypeptide having at least 90%, such as at least 95%, sequence identity to SEQ ID NO: 16;
(b) a polypeptide having at least 90%, such as at least 95%, sequence identity to SEQ ID NO: 16 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
(c) a polypeptide having at least 90%, such as at least 95%, sequence identity to

SEQ ID NO: 16 or a variant thereof wherein the polypeptide comprises the following substitutions T231R and N233R;

(v) one or more pectate lyases selected from the group consisting of:
(a) a polypeptide having at least 80%, such as at least 85%, at least 90%, or at least 95% sequence identity to SEQ ID NO: 17; and
(b) a polypeptide having at least 80%, such as at least 85%, at least 90%, or at least 95% sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397; or

(vi) one or more mannanases selected from the group consisting of:
(a) a polypeptide having at least 80%, such as at least 85%, at least 90%, or at least 95% sequence identity to amino acids 31 to 330 of SEQ ID NO: 2 of WO 99/64619;
(b) a polypeptide having at least 80%, such as at least 85%, at least 90%, or at least 95% sequence identity to amino acids 32 to 334 of SEQ ID NO: 6 of WO 99/64619;
(c) a polypeptide having at least 80%, such as at least 85%, at least 90%, or at least 95% sequence identity to amino acids 33 to 331 of SEQ ID NO: 12 of WO 99/64619; and
(d) a polypeptide having at least 80%, such as at least 85%, at least 90%, or at least 95% sequence identity to amino acids 68 to 369 of SEQ ID NO: 16 of WO 99/64619.

In an even more preferred embodiment the multi-enzyme composition comprises six or more polypeptides selected among:

(i) one or more proteases selected from the group consisting of:
(a) a polypeptide having at least 90%, such as at least 95%, sequence identity to SEQ ID NO: 1;
(b) a polypeptide having at least 90%, such as at least 95%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90%, such as at least 95%, sequence identity to SEQ ID NO: 2; (d) a polypeptide having at least 90%, such as at least 95%, sequence identity SEQ ID NO: 2 or a variant thereof wherein the polypeptide comprises a substitution in one or more of positions: 3, 4, 99, 101, 103, 104, 159, 194, 199, 205 and/or 217; and
(e) a polypeptide having at least 90%, such as at least 95%, sequence identity SEQ ID NO: 23.

(ii) one or more amylases selected from the group consisting of:
(a) a polypeptide having at least 90%, such as at least 95%, sequence identity to SEQ ID NO: 3;
(b) a polypeptide having at least 90%, such as at least 95%, sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90%, such as at least 95%, sequence identity to SEQ ID NO: 4
(d) a polypeptide having at least 90%, such as at least 95%, sequence identity to the hybrid polypeptide of SEQ ID NO: 5
(e) a polypeptide having at least 90%, such as at least 95%, sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90%, such as at least 95%, sequence identity to SEQ ID NO: 6;
(g) a polypeptide having at least 90%, such as at least 95%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
(h) a polypeptide having at least 90%, such as at least 95%, sequence identity to SEQ ID NO: 7, SEQ ID NO: 8 or SEQ ID NO: 9;
(i) a polypeptide having at least 90%, such as at least 95%, sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184 195, 206, 243, 260, 304 and/or 476;
(j) a polypeptide having at least 90%, such as at least 95%, sequence identity to SEQ ID NO: 10;
(k) a polypeptide having at least 90%, such as at least 95%, sequence identity to SEQ ID NO: 11;
(l) a polypeptide having at least 90%, such as at least 95%, sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
(m) a polypeptide having at least 90%, such as at least 95%, sequence identity to SEQ ID NO: 12;
(n) a polypeptide having at least 90%, such as at least 95%, sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
(o) a polypeptide having at least 90%, such as at least 95%, sequence identity to SEQ ID NO: 13; and
(p) a polypeptide having at least 90%, such as at least 95%, sequence identity to SEQ ID NO: 13 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484;

(iii) one or more cellulases selected from the group consisting of:
(a) a polypeptide having at least 90%, such as at least 95%, sequence identity to the amino acid sequence of position 1 to position 773 of SEQ ID NO:14; and
(b) a polypeptide having at least 80%, such as at least 85%, such as at least 90%, such as at least 95% sequence identity to SEQ ID NO: 15; and
(c) a polypeptide having at least 80%, such as at least 85%, such as at least 90%, such as at least 95% sequence identity to SEQ ID NO: 15 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
(d) a polypeptide having at least 80%, such as at least 85%, such as at least 90%, such as at least 95% sequence identity to SEQ ID NO: 22;

(iv) one or more lipases selected from the group consisting of:
(a) a polypeptide having at least 90%, such as at least 95%, sequence identity to SEQ ID NO: 16;
(b) a polypeptide having at least 90%, such as at least 95%, sequence identity to SEQ ID NO: 16 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
(c) a polypeptide having at least 90%, such as at least 95%, sequence identity to SEQ ID NO: 16 or a variant thereof wherein the polypeptide comprises the following substitutions T231 R and N233R;

(v) one or more pectate lyases selected from the group consisting of:
(a) a polypeptide having at least 80%, such as at least 85%, at least 90%, or at least 95% sequence identity to SEQ ID NO: 17; and
(b) a polypeptide having at least 80%, such as at least 85%, at least 90%, or at least 95% sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397; or

(vi) one or more mannanases selected from the group consisting of:
(a) a polypeptide having at least 80%, such as at least 85%, at least 90%, or at least 95% sequence identity to amino acids 31 to 330 of SEQ ID NO: 2 of WO 99/64619;
(b) a polypeptide having at least 80%, such as at least 85%, at least 90%, or at least 95% sequence identity to amino acids 32 to 334 of SEQ ID NO: 6 of WO 99/64619;
(c) a polypeptide having at least 80%, such as at least 85%, at least 90%, or at least 95% sequence identity to amino acids 33 to 331 of SEQ ID NO: 12 of WO 99/64619; and
(d) a polypeptide having at least 80%, such as at least 85%, at least 90%, or at least 95% sequence identity to amino acids 68 to 369 of SEQ ID NO: 16 of WO 99/64619.

In a most preferred embodiment, the multi-enzyme composition comprises one or more enzymes from each of the enzyme classes described above optionally together with one or more xyloglucanases, cutinases, xanthanases and/or peroxidases.

For use in the method of the invention the enzymes in the multi-enzyme composition is added in amounts sufficient to achieve the desired cleaning benefit in the final solution. The multi-enzyme composition may be concentrated and consequently a small amount of the composition is needed in order to achieve the desired concentration of the enzymes in the final wash liquor, or the multi-enzyme composition may be less concentrated in which case a larger amount of the composition must be added to the wash liquor. It is within the capabilities of the average practitioner to select a suitable dosing of a given multi-enzyme composition based on the concentration of the individual enzymes therein.

In one embodiment of the invention the multi-enzyme composition is dosed separately as a liquid enzyme formulation and has a concentration so that the recommended amount of the enzymes can be dosed by adding between 0.01 mL and 100 mL liquid enzyme formulation per kg dry textile, such as 0.1 mL and 10 mL enzyme formulation per kg dry textile, preferably 0.5 mL and 5 mL liquid enzyme formulation per kg dry textile and most preferably between 1 mL and 2 mL liquid enzyme formulation per kg dry textile

In one embodiment of the present invention, the multi-enzyme composition is added in an amount so that each enzyme used per wash cycle is independently present in the wash liquor in an amount corresponding to 0.0001-500 mg of enzyme protein, such as 0.001-200 mg of enzyme protein, preferably 0.01-100 mg of enzyme protein, more preferably 0.05-50 mg of enzyme protein, even more preferably 0.2-20 mg of enzyme protein per kilogram of dry textile. For example, the amount of a protease may be 15 mg of enzyme protein per kilogram of dry textile whilst the amount of an amylase may be 0.2 mg of enzyme protein per kilogram of dry textile and the amount of a cellulase may be 3 mg of enzyme protein per kilogram of dry textile.

In general the properties of the selected enzyme(s) should be compatible with the selected detergent, (i.e., pH-optimum, compatibility with other enzymatic and non-enzymatic ingredients, etc.), and the enzyme(s) should be present in effective amounts.

In one embodiment of the invention the multi-enzyme composition comprises:

a) a protease having at least 90%, such as at least 95%, sequence identity to SEQ ID NO: 1;

b) an amylase having at least 90%, such as at least 95%, sequence identity to SEQ ID NO: 11;

c) a polypeptide having at least 80%, such as at least 85%, such as at least 90%, such as at least 95% sequence identity to SEQ ID NO: 15;

d) a cellulase having at least 90%, such as at least 95%, sequence identity to the amino acid sequence of position 1 to position 773 of SEQ ID NO:14 or a cellulase having at least 80%, such as at least 85%, such as at least 90%, such as at least 95% sequence identity to SEQ ID NO: 22;

e) a lipase having at least 90%, such as at least 95%, sequence identity to SEQ ID NO: 16 or a variant thereof wherein the polypeptide comprises the following substitutions T231R and N233R;

f) a pectate lyase having at least 80%, such as at least 85%, at least 90%, or at least 95% sequence identity to SEQ ID NO: 17; and

g) a mannanase having at least 80%, such as at least 85%, at least 90%, or at least 95% sequence identity to amino acids 31 to 330 of SEQ ID NO: 18.

In one embodiment of the invention the method comprises using from 0.1 to 2.0 g of a granulate multi-enzyme composition per kg dry textile, wherein the composition comprises:

a) 35-45 wt % granulates of a protease having at least 90%, such as at least 95%, sequence identity to SEQ ID NO: 1;

b) 8-18 wt % granulates of an amylase having at least 90%, such as at least 95%, sequence identity to SEQ ID NO: 11;

c) 2.5-5.5 wt % granulates of a polypeptide having at least 80%, such as at least 85%, such as at least 90%, such as at least 95% sequence identity to SEQ ID NO: 15;

d) 7.5-12.5 wt % granulates of a a cellulase having at least 90%, such as at least 95%, sequence identity to the amino acid sequence of position 1 to position 773 of SEQ ID NO:14

e) 6-11 wt % granulates of a lipase having at least 90%, such as at least 95%, sequence identity to SEQ ID NO: 16 or a variant thereof wherein the polypeptide comprises the following substitutions T231 R and N233R;

f) 7.5-12.5 wt % granulates of a pectate lyase having at least 80%, such as at least 85%, at least 90%, or at least 95% sequence identity to SEQ ID NO: 17; and

g) 7.5-12.5 wt % granulates of a mannanase having at least 80%, such as at least 85%, at least 90%, or at least 95% sequence identity to amino acids 31 to 330 of SEQ ID NO: 18.

In one embodiment of the invention the method comprises using 0.5 g of a granulate multi-enzyme composition per kg dry textile, wherein the composition comprises:

a) 41.3 wt % granulates of a protease having at least 90%, such as at least 95%, sequence identity to SEQ ID NO: 1;

b) 13.3 wt % granulates of an amylase having at least 90%, such as at least 95%, sequence identity to SEQ ID NO: 11;

c) 4.7 wt % granulates of a polypeptide having at least 80%, such as at least 85%, such as at least 90%, such as at least 95% sequence identity to SEQ ID NO: 15;

d) 10.7 wt % granulates of a a cellulase having at least 90%, such as at least 95%, sequence identity to the amino acid sequence of position 1 to position 773 of SEQ ID NO:14

e) 8.7 wt % granulates of a lipase having at least 90%, such as at least 95%, sequence identity to SEQ ID NO: 16 or a variant thereof wherein the polypeptide comprises the following substitutions T231 R and N233R;

f) 10.7 wt % granulates of a pectate lyase having at least 80%, such as at least 85%, at least 90%, or at least 95% sequence identity to SEQ ID NO: 17; and

g) 10.7 wt % granulates of a mannanase having at least 80%, such as at least 85%, at least 90%, or at least 95% sequence identity to amino acids 31 to 330 of SEQ ID NO: 18.

In one embodiment of the invention the method comprises using a multi-enzyme composition comprising:

a) a polypeptide having at least 90%, such as at least 95%, sequence identity SEQ ID NO: 23;

b) a polypeptide having at least 90%, such as at least 95%, sequence identity to SEQ ID NO: 16 or a variant thereof wherein the polypeptide comprises the following substitutions T231R and N233R; and

c) a polypeptide having at least 90%, such as at least 95%, sequence identity to SEQ ID NO: 6.

In one embodiment the multi-enzyme composition further comprises a polypeptide having at least 90%, such as at least 95%, sequence identity to the amino acid sequence of position 1 to position 773 of SEQ ID NO:14.

In one embodiment of the invention the method comprises adding 0.1 to 6.0 g of a liquid multi-enzyme composition per kg dry textile, wherein the multi-enzyme composition comprises:

a) a protease in a concentration affording an activity of 1.0-2.0 KNPU(S)/g, having at least 90%, such as at least 95%, sequence identity to SEQ ID NO: 1;

b) an amylase in a concentration affording an activity of 0.15-0.50 SNU/g, having at least 90%, such as at least 95%, sequence identity to SEQ ID NO: 11;

c) a polypeptide in a concentration affording an activity of 50-100 CNU(R)/g, having at least 80%, such as at least 85%, such as at least 90%, such as at least 95% sequence identity to SEQ ID NO: 15;

d) a cellulase in a concentration affording an activity of 30-80 ECU/g, having at least 90%, such as at least 95%, sequence identity to the amino acid sequence of position 1 to position 773 of SEQ ID NO:22;

e) a lipase in a concentration affording an activity of 2.0-4.0 KLU/g, having at least 90%, such as at least 95%, sequence identity to SEQ ID NO: 16 or a variant thereof wherein the polypeptide comprises the following substitutions T231 R and N233R;

f) a pectate lyase in a concentration affording an activity of 9.0-16.0 PDEU/g, having at least 80%, such as at least 85%, at least 90%, or at least 95% sequence identity to SEQ ID NO: 17; and

g) a mannanase in a concentration affording an activity of 0.025-0.075 MIU/g, having at least 80%, such as at least 85%, at least 90%, or at least 95% sequence identity to amino acids 31 to 330 of SEQ ID NO: 18.

In one embodiment the comprises adding 2.0 g of a liquid multi-enzyme composition per kg dry textile, wherein the multi-enzyme composition comprises:

a) a protease in a concentration affording an activity of 1.5 KNPU(S)/g, having at least 90%, such as at least 95%, sequence identity to SEQ ID NO: 1;

b) an amylase in a concentration affording an activity of 0.30 SNU/g, having at least 90%, such as at least 95%, sequence identity to SEQ ID NO: 11;

c) a polypeptide in a concentration affording an activity of 72.4 CNU(R)/g, having at least 80%, such as at least 85%, such as at least 90%, such as at least 95% sequence identity to SEQ ID NO: 15;

d) a cellulase in a concentration affording an activity of 53.6 ECU/g, having at least 90%, such as at least 95%, sequence identity to the amino acid sequence of position 1 to position 773 of SEQ ID NO:22;

e) a lipase in a concentration affording an activity of 2.7 KLU/g, having at least 90%, such as at least 95%, sequence identity to SEQ ID NO: 16 or a variant thereof wherein the polypeptide comprises the following substitutions T231 R and N233R;

f) a pectate lyase in a concentration affording an activity of 13.4 PDEU/g, having at least 80%, such as at least 85%, at least 90%, or at least 95% sequence identity to SEQ ID NO: 17; and

g) a mannanase in a concentration affording an activity of 0.050 MIU/g, having at least 80%, such as at least 85%, at least 90%, or at least 95% sequence identity to amino acids 31 to 330 of SEQ ID NO: 18.

KLU/g=Kilo Lipase Unit/g

SNU/g=Stainzyme® Novozymes Unit/g

KNPU(S)/g=Kilo Novo Protease Unit/g

PDEU/g=pectin-degrading enzyme unit/g

MIU(M)/g=Mannanase Immuno Unit/g

ECU/g=Endo-Cellulase Unit/g

CNU(R)/g=Cellulase Novozymes Unit/g

### Proteases

The protease may be of animal, vegetable or microbial origin, including chemically or genetically modified mutants. Microbial origin is preferred. It may be an alkaline protease, such as a serine protease or a metalloprotease. A serine protease may for example be of the 51 family, such as trypsin, or the S8 family such as subtilisin. A metalloproteases protease may for example be a thermolysin from e.g. family M4, M5, M7 or M8.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family. In one aspect of the invention the protease may be a subtilase, such as a subtilisin or a variant hereof. Further the subtilases (and the serine proteases) are characterised by having two active site amino acid residues apart from the serine, namely a histidine and an aspartic acid residue.

Examples of subtilisins are those derived from Bacillus such as subtilisin lentus, Bacillus lentus, subtilisin Novo, subtilisin Carlsberg, Bacillus licheniformis, subtilisin BPN′, subtilisin 309, subtilisin 147 and subtilisin 168 described in WO 89/06279 and protease PD138 (WO 93/18140). Additional serine protease examples are described in WO 98/020115, WO 01/44452, WO 01/58275, WO 01/58276, WO 03/006602 and WO 04/099401. Preferred subtilisin variants are those having at least 90%, such as at least 95%, sequence identity to SEQ ID NO: 4 of WO 03/006602. More preferred variants are those having at least 90%, such as at least 95%, sequence identity to SEQ ID NO: 4 of WO 03/006602 wherein the polypeptide comprises a substitution, deletion or insertion in one or more of the following positions: 3, 4, 9, 15, 27, 36, 68, 76, 87, 95, 96, 97, 98, 99, 100, 101, 102, 103, 104, 106, 118, 120, 123, 128, 129, 130, 160, 167, 170, 194, 195, 199, 205, 217, 218, 222, 232, 235, 236, 245, 248, 252 and 274 using BPN′ numbering. Even more preferred subtilisin variants of SEQ ID NO: 4 of WO 03/006602, using BPN′ numbering, are those comprising a substitution, deletion or insertion in one or more of the following positions: S3T, V41, S9R, A15T, K27R, *36D, V68A, N76D, N87S,R, *97E, A98S, S99G,D,A, S99AD, S101G,M,R S103A, V1041,Y,N, S106A, G118V,R, H120D,N, N123S, S128L, P129Q, S130A, G160D, Y167A, R1705, A194P, G195E, V199M, V2051, L217D, N218D, M222S, A232V, K235L, Q236H, Q245R, N252K, T274A.

Further subtilisins of interest are those having at least 90%, such as at least 95%, sequence identity to the amino acid sequence shown in FIG. 29 of U.S. Pat. No. 5,352,604. Preferred subtilisin variants of the amino acid sequence shown in FIG. 29 of U.S. Pat. No. 5,352,604 are those having at least 90%, such as at least 95%, sequence identity to the amino acid sequence shown in FIG. 29 of U.S. Pat. No. 5,352,604 wherein the polypeptide comprises a substitution in one or more of positions: 3, 4, 99, 101, 103, 104, 159, 194, 199, 205 and/or 217.

Examples of trypsin-like proteases are trypsin (e.g. of porcine or bovine origin) and the Fusarium protease described in WO 89/06270 and WO 94/25583. Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Examples of metalloproteases are the neutral metalloprotease as described in WO 07/044993.

Preferred commercially available protease enzymes include Alcalase™, Coronase™, Coronase Ultra™ and Coronase Evity™, Duralase™, Durazym™, Esperase™, Everlase™, Kannase™, Liquanase™, Liquanase Evity™, Liquanase Ultra™, Ovozyme™, Polarzyme™, Primase™, Relase™, Savinase™, Savinase Evity™ and Savinase Ultra™, (Novozymes NS), Axapem™ (Gist-Brocases N.V.), BLAP and BLAP X (Henkel AG & Co. KGaA), Excellase™, FN2™, FN3™, FN4™, Maxacal™, Maxapem™, Maxatase™, Properase™, Purafast™, Purafect™, Purafect OxP™, Purafect™ Prime and Puramax™ (Danisco US Inc, formerly Genencor International Inc.).

### Amylases

The amylase may be an alpha-amylase, a beta-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Examples of amylases are those having SEQ ID NO: 3 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444 of SEQ ID NO: 3 in WO 95/10603.

Further amylases which can be used are amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylase examples are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48+T49+G107+H156+A181+N190+I201+A209+Q264.

Further amylase examples are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, I206, E212, E216 and K269. Particularly preferred amylases are those having deletion in positions G182 and H183 or positions H183 and G184.

Additional amylases are those having SEQ ID NO: 1, SEQ ID NO: 2 or SEQ ID NO: 7 of WO 96/023873 or variants thereof having 90% sequence identity to SEQ ID NO: 1, SEQ ID NO: 2 or SEQ ID NO: 7. Preferred variants of SEQ ID NO: 1, SEQ ID NO: 2 or SEQ ID NO: 7 are those having a substitution, a deletion or an insertion in one or more of the following positions: 140, 181, 182, 183, 184, 195, 206, 212, 243, 260, 269, 304 and 476. More preferred variants are those having a deletion in positions 182 and 183 or positions 183 and 184. Most preferred amylase variants of SEQ ID NO: 1, SEQ ID NO: 2 or SEQ ID NO: 7 are those having a deletion in positions 183 and 184 and a substitution in positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further amylases which can be used are amylases having SEQ ID NO: 2 of WO 09/061380 or variants thereof having 90% sequence identity to SEQ ID NO: 2. Preferred variants of SEQ ID NO: 2 are those having a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T1311, T165I, K178L, T182G, M201L, F202Y, N225E,R, N272E,R, S243Q,A,E,D, Y305R, R309A, Q320R, Q359E, K444E and G475K and/or deletion in position R180 and/or S181. Most preferred amylase variants of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T1311+T1651+K178L+T182G+Y305R+G475K wherein the variant optionally further comprises a substitution at position 243 and/or a deletion at position 180 and/or position 181.

Other examples of amylases are the alpha-amylase having SEQ ID NO: 12 in WO01/66712 or a variant having at least 90%, such as at least 95%, sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Commercially available amylases are Duramyl™, Termamyl™, Fungamyl™, Stainzyme™, Stainzyme Plus™ and Stainzyme Plus Evity™, Natalase™ and BAN™ (Novozymes NS), Rapidase™ and Purastar™ (from Genencor International Inc.).

### Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Example of preferred cellulases exhibiting endo-beta-1,4-glucanase activity (EC 3.2.1.4) are those having a sequence identity of at least 97% to the amino acid sequence of position 1 to position 773 of SEQ ID NO:2 in WO02/099091.

Other examples of preferred cellulases include the family 45 cellulases having at least 70% sequence identity to SEQ ID NO: 5 of WO98/12307 or a variant thereof having substitution, insertion and/or deletion at one or more of the positions corresponding to the following positions in SEQ ID NO: 5 of WO 98/12307, 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200.

Commercially available cellulases include Celluclean™ and Celluclean Evity™, and Carezyme™ and Carezyme Premium™ (Novozymes NS), Clazinase™, and Puradax HA™ (Genencor International Inc.), and KAC-500(B)™ (Kao Corporation), and Biotouch (AB Enzymes).

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred lipases are those having at least 90%, such as at least 95%, sequence identity to SEQ ID NO: 2 of WO07/87508. More preferred lipases are those having at least 90%, such as at least 95%, sequence identity to SEQ ID NO: 2 of WO07/87508 and having a substitution, a deletion or an insertion in one or more of the following positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272. Even more preferred lipases are those having at least 90%, such as at least 95%, sequence identity to SEQ ID NO: 2 of WO07/87508, having the substitutions T231 R and N233R and optionally a substitution in one or more of the following positions: 4, 24, 27, 33, 57, 58, 60, 62, 81, 83, 84, 86, 87, 90, 91, 94, 96, 99, 101, 102, 147, 150, 190, 202, 209, 210, 211, 227, 249, 255, 256, 270, 271 and 272.

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

Preferred commercial lipase products include include Lipolase™, Lipex™ and Lipex Evity™, Lipolex™ and Lipoclean™ (Novozymes NS), Lumafast (originally from Genencor) and Lipomax (originally from Gist-Brocades).

### Pectate Lyases

Suitable pectate lyases include those of bacterial origin. Chemically or modified or protein engineered mutants are included. Suitable pectate lyases include pectate lyases from the genus Bacillus e.g., the bacterial pectate lyase produced from Bacillus licheniformis disclosed in WO99/27083, or the bacterial pectate lyase produced from Bacillus subtilis disclosed in WO02/092741.

Other suitable pectate lyases include pectate lyases having at least 80%, such as at least 85%, at least 90%, or at least 95% sequence identity to SEQ ID NO: 2 of WO2003/095638 or a variant thereof having an alteration, such as a substitution, an insertion of an amino acid downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397.

Commercially available pectate lyases include Xpect™ (Novozymes NS).

### Mannanases

Suitable mannanases include those of bacterial origin. Chemically or modified or protein engineered mutants are included. Suitable mannanases include mannanases from the genus Bacillus e.g., the bacterial Mannanases produced from Bacillus licheniformis, Bacillus agara-dhaerens, Bacillus halodurans, Bacillus sp. AAI12, Bacillus sp. 1633 or Bacillus sp. AA349 disclosed in WO99/64619.

Suitable mannanases are mannanases having a sequence that is at least 80%, such as at least 85%, at least 90%, or at least 95% identical to amino acids 31 to 330 of SEQ ID NO: 2 of WO99/64619. Further mannanases are mannanases having a sequence that is at least 80%, such as at least 85%, at least 90%, or at least 95% identical to amino acids 32 to 334 of SEQ ID NO: 6 of WO99/64619. Other mannanases are those having a sequence that is at least 80%, such as at least 85%, at least 90%, or at least 95% identical to amino acids 33 to 331 of SEQ ID NO: 12 of WO99/64619. Suitable mannanases are mannanases having a sequence that is at least 80%, such as at least 85%, at least 90%, or at least 95% identical to amino acids 68 to 369 of SEQ ID NO: 16 of WO99/64619.

Commercially available mannanases include Mannaway™ (Novozymes A/S).

### Xyloglucanases

Suitable xyloglucanases include those of bacterial origin. Chemically modified or protein engineered mutants are included. Suitable xyloglucanases include xyloglucanases from the genera Bacillus, Pseudomonas and Paenibacillus e.g., the bacterial xyloglucanase produced from Paenibacillus polymyxa disclosed in WO2001/062903.

Especially suitable xyloglucanases are the alkaline or neutral xyloglucanases having whiteness benefits. Examples of such xyloglucanases are described in WO2001/062903. Other examples are xyloglucanase variants such as those described in WO2009/147210.

Other examples of suitable xyloglucanases are xyloglucanases having at least 80%, such as at least 85%, at least 90%, or at least 95% sequence identity to SEQ ID NO: 3 of WO2009/147210, or a variant having a substitution, deletion or insertion in one or more of the positions 68, 123, 156, 118, 200, 129, 137, 193, 92, 83, 149, 34, 340, 332, 9, 76, 331, 310, 324, 498, 395, 366, 1, 374, 7, 140, 8, 14, 21, 211, 37, 45, 13, 78, 87, 436,101, 104, 111, 306, 117, 119, 414, 139, 268, 142, 159, 164, 102, 168, 176, 180, 482, 183, 202, 206, 217, 4, 222, 19, 224, 228, 232, 2, 240, 244, 5, 247, 249, 328, 252, 259, 406, 267, 269, 275, 179, 166, 278, 281, 288, 298, 301, 18, 302, 165, 80, 303, 316, 169, 322, 120, 146, 342, 348, 147, 353, 380, 468, 382, 383, 38, 384, 389, 391, 10, 392, 396, 177, 397, 399, 409, 237, 413, 253, 415, 418, 40, 443, 445, 148, 449, 225, 450, 454, 3, 455, 456, 299, 461, 470, 204, 476, 488, 347, and 507 using the numbering of SEQ ID NO:3 of WO2009/147210. Preferred variants of SEQ ID NO:3 of WO2009/147210 are those having the substitution selected among Q68H,N,L; S123P,T; R156Y,F,V,I,K,W,L,M; K118A,R; G200P,E,S,D; K129T,A,S; Q137E; H193T,S,D; T92V,I,A,S; A83E; Q149E; L34F,I,V; R340T,N; S332P; T9D; S76W,V,I,K,R,T; N331F,C; M310I,V,L; D324N; G498A,D; D395G and D366H.

Commercially available xyloglucanases include Whitezyme™ (Novozymes NS).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes A/S).

### Detergent Compositions

In one embodiment, the invention is directed to detergent compositions comprising a multi-enzyme composition of the present invention in combination with one or more additional detergent composition components. The choice of additional components is within the skill of the artisan and includes conventional ingredients, including the exemplary non-limiting components set forth below.

### Alkalis

The detergent composition may comprise one or more alkalis. Non-limiting examples of strong alkalis include e.g. sodium hydroxide, potassium hydroxide, lithium hydroxide, calcium hydroxide or magnesium hydroxide and the detergent composition may comprise a combination of one or more alkalis, such as both sodium hydroxide and potassium hydroxide. The alkali may be present in a level of about 0% to 50%, such as 0.1% to 35%, such as 0.5% to 17%, such as 1% to 12%, such as 1% to 7%, such as 1% to 4% by weight. Since alkalis cause significant wear on the fabric/textile, then it is beneficial to have as little alkali present as possible. Thus a preferred embodiment is less than 17% alkali by weight, such as less than 12% alkali by weight, such as less than 7% alkali by weight, such as less than 4% alkali by weight, such as less than 1% alkali by weight, such as no alkali present.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and includes any conventional surfactant(s) known in the art. Any surfactant known in the art for use in detergents may be utilized.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about _{—}0.1_% to about 40% by weight of a cationic surfactant. Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

When included therein the detergent will usually contain from about 0.2% to about 40% by weight of a non-ionic surfactant, for example from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 0.05% to about 20% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 0.1% to about 20% by weight of a zwitterionic surfactant. Non-limiting examples of zwitterionic surfactants include betaine, alkyldimethylbetaine, sulfobetaine, and combinations thereof.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favour spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behaviour, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-5% by weight, such as about 0.5 to about 5%, or about 3% to about 5%, of a hydrotrope. Any hydrotrope known in the art for use in detergents may be utilized. Non-limiting examples of hydrotropes include sodium benzene sulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

Builders and Co-Builders

The detergent composition may contain about 0-65% by weight, such as about 2% to about 45%, such as 5-35%, such as 10-30% of a detergent builder or co-builder, or a mixture thereof. The builder and/or co-builder may particularly be a chelating agent that forms water-soluble complexes with Ca and Mg. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as iminodiethanol), triethanolamine (TEA, also known as 2,2′,2″-nitrilotriethanol), and carboxymethyl inulin (CMI), and combinations thereof.

The detergent composition may also contain 0-15% by weight, such as about 1% to about 5%, of a detergent co-builder, or a mixture thereof. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)-ethylidenediamine-N,N,N′-triacetate (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

The detergent composition may contain 0-45% by weight, such as about 0% to about 30%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, alkali metal salts of hypochlorite, hydrogen peroxide, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with peroxygen bleach like hydrogen peroxide to form a peracid. The peracid thus formed constitutes the activated bleach. Suitable bleach activators to be used herein include those belonging to the class of esters amides, imides or anhydrides. Suitable examples are tetracetylethylene diamine (TAED), sodium 4-[(3,5,5-trimethylhexanoyl)oxy]benzene sulfonate (ISONOBS), diperoxy dodecanoic acid, 4-(dodecanoyloxy)benzenesulfonate (LOBS), 4-(decanoyloxy)benzenesulfonate, 4-(decanoyloxy)benzoate (DOBS), 4-(nonanoyloxy)benzenesulfonate (NOBS), and/or those disclosed in WO98/17767. A particular family of bleach activators of interest was disclosed in EP624154 and particularly preferred in that family is acetyl triethyl citrate (ATC). ATC or a short chain triglyceride like triacetin has the advantage that it is environmental friendly as it eventually degrades into citric acid and alcohol. Furthermore acetyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthalimido)peroxyhexanoic acid (PAP). Preferably the bleaching system may be a liquid, emulsion or slurry dosed and stored separately, comprising 6-(phthalimido)peroxy hexanoic acid (PAP), peroxycarboxylic acids such as peracetic acid or longer aliphatic peroxycarboxylic acids such as peroctanoic acid, or any mixtures thereof. The bleaching system may also include a bleach catalyst. In some embodiments the bleach component may be an organic catalyst selected from the group consisting of organic catalysts having the following formulae:

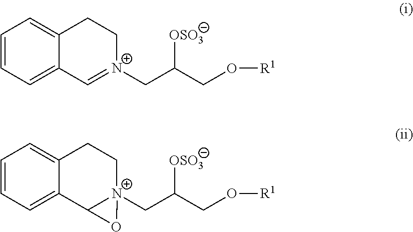

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g. in WO2007/087258, WO2007/087244, WO2007/087259 and WO2007/087242. Suitable photobleaches may for example be sulfonated zinc phthalocyanine

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fibre protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

Dispersants: The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

Dye Transfer Inhibiting Agents: The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent whitening agent: The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

Soil release polymers: The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose derivatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

Anti-redeposition agents: The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated poly-ethyleneimines. The cellulose based polymers described under soil release polymers above may also function as anti-redeposition agents.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Protease Inhibitor

The protease inhibitor maybe any compound which stabilises or inhibits the protease so that the protease or other enzyme(s) in the multi-enzyme composition are not degraded. Examples of protease inhibitors are aprotinin, bestatin, calpain inhibitor I and II, chymostatin, leupeptin, pepstatin, phenylmethanesulfonyl fluoride (PMSF), boric acid, borate, borax, boronic acids, phenylboronic acids such as 4-formylphenylboronic acid (4-FPBA), peptide aldehydes or hydrosulfite adducts or hemiacetal adducts thereof and peptide trifluromethyl ketones. There may be one or more protease inhibitors, such as 5,4,3,2 or 1 inhibitor(s) of which at least one is a peptide aldehyde, a hydrosulfite adduct or a hemiacetal adduct thereof.

### Peptide Aldehyde Inhibitor

The peptide aldehyde may have the formula P-(A)_{y}-L-(B)ₓ-B⁰—H or a hydrosulfite adduct or hemiacetal adduct thereof, wherein:
i. H is hydrogen;
ii. B⁰ is a single amino acid residue with L- or D-configuration of the formula NH—CH(R)—C(═O)—;
iii. x is 1, 2 or 3 for (B)ₓ, and B is independently a single amino acid connected to B⁰ via the C-terminal of the B amino acid
iv. L is absent or L is independently a linker group of the formula —C(═O)—, —C(═O)—C(═O)—, —C(═S)—, —C(═S)—C(═S)— or —C(═S)—C(═O)—;

v. y is 0, 1 or 2 for (A)_{y}, and A is independently a single amino acid residue connected to L via the N-terminal of the A amino acid, with the proviso that if L is absent then A is absent;
vi. P is selected from the group consisting of hydrogen and an N-terminal protection group, with the proviso that if L is absent then P is an N-terminal protection group;
vii. R is independently selected from the group consisting of C₁₋₆ alkyl, C₆₋₁₀ aryl or C₇₋₁₀ arylalkyl optionally substituted with one or more, identical or different, substituent's R′;
viii. R′ is independently selected from the group consisting of halogen, —OH, —OR″, —SH, —SR″, —NH₂, —NHR″, —NR″₂, —CO₂H, —CONH₂, —CONHR″, —CONR″₂, —NHC(═N)NH₂; and
ix. R″ is a C₁₋₆ alkyl group.

x may be 1, 2 or 3 and therefore B may be 1, 2 or 3 amino acid residues respectively. Thus, B may represent B¹, B²-B¹ or B³-B²-B¹, where B³, B² and B¹ each represent one amino acid residue. y may be 0, 1 or 2 and therefore A may be absent, or 1 or 2 amino acid residues respectively having the formula A^{l} or A²-A¹ wherein A² and A^{l} each represent one amino acid residue.

B⁰ may be a single amino acid residue with L- or D-configuration, which is connected to H via the C-terminal of the amino acid, wherein R is a C₁₋₆ alkyl, C₆₋₁₀ aryl or C₇₋₁₀ arylalkyl side chain, such as methyl, ethyl, propyl, isopropyl, butyl, isobutyl, phenyl or benzyl, and wherein R may be optionally substituted with one or more, identical or different, substituent's R′. Particular examples are the D- or L-form of arginine (Arg), 3,4-dihydroxyphenylalanine, isoleucine (Ile), leucine (Leu), methionine (Met), norleucine (Nle), norvaline (Nva), phenylalanine (Phe), m-tyrosine, p-tyrosine (Tyr) and valine (Val). A particular embodiment is when B⁰ is leucine, methionine, phenylalanine, p-tyrosine and valine.

B¹, which is connected to B⁰ via the C-terminal of the B¹ aminoacid, may be an aliphatic, hydrophobic and/or neutral amino acid. Examples of B¹ are alanine (Ala), cysteine (Cys), glycine (Gly), isoleucine (Ile), leucine (Leu), norleucine (Nle), norvaline (Nva), proline (Pro), serine (Ser), threonine (Thr) and valine (Val). Particular examples of B¹ are alanine, glycine, isoleucine, leucine and valine. A particular embodiment is when B¹ is alanine, glycine or valine.

If present, B², which is connected to B¹ via the C-terminal of the B² amino acid, may be an aliphatic, hydrophobic, neutral and/or polar amino acid. Examples of B² are alanine (Ala), arginine (Arg), capreomycidine (Cpd), cysteine (Cys), glycine (Gly), isoleucine (Ile), leucine (Leu), norleucine (Nie), norvaline (Nva), phenylalanine (Phe), proline (Pro), serine (Ser), threonine (Thr), and valine (Val). Particular examples of B² are alanine, arginine, capreomycidine, glycine, isoleucine, leucine, phenylalanine and valine. A particular embodiment is when B² is arginine, glycine, leucine, phenylalanine or valine.

B³, which if present is connected to B² via the C-terminal of the B³ amino acid, may be a large, aliphatic, aromatic, hydrophobic and/or neutral amino acid. Examples of B³ are isoleucine (Ile), leucine (Leu), norleucine (Nie), norvaline (Nva), phenylalanine (Phe), phenylglycine, tyrosine (Tyr), tryptophan (Trp) and valine (Val). Particular examples of B³ are leucine, phenylalanine, tyrosine and tryptophan.

The linker group L may be absent or selected from the group consisting of —C(═O)—, —C(═O)—C(═O)—, —C(═S)—, —C(═S)—C(═S)— or —C(═S)—C(═O)—. Particular embodiments of the invention are when L is absent or L is a carbonyl group —C(═O)—.

A¹, which if present is connected to L via the N-terminal of the amino acid, may be an aliphatic, aromatic, hydrophobic, neutral and/or polar amino acid. Examples of A¹ are alanine (Ala), arginine (Arg), capreomycidine (Cpd), glycine (Gly), isoleucine (Ile), leucine (Leu), norleucine (Nie), norvaline (Nva), phenylalanine (Phe), threonine (Thr), tyrosine (Tyr), tryptophan (Trp) and valine (Val). Particular examples of A^{l} are alanine, arginine, glycine, leucine, phenylalanine, tyrosine, tryptophan and valine. A particular embodiment is when B² is leucine, phenylalanine, tyrosine or tryptophan.

The A² residue, which if present is connected to A¹ via the N-terminal of the amino acid, may be a large, aliphatic, aromatic, hydrophobic and/or neutral amino acid. Examples of A² are arginine (Arg), isoleucine (Ile), leucine (Leu), norleucine (Nie), norvaline (Nva), phenylalanine (Phe), phenylglycine, Tyrosine (Tyr), tryptophan (Trp) and valine (Val). Particular examples of A² are phenylalanine and tyrosine.

The N-terminal protection group P (if present) may be selected from formyl, acetyl (Ac), benzoyl (Bz), trifluoroacetyl, methoxysuccinyl, aromatic and aliphatic urethane protecting groups such as fluorenylmethyloxycarbonyl (Fmoc), methoxycarbonyl, (fluoromethoxy)carbonyl, benzyloxycarbonyl (Cbz), t-butyloxycarbonyl (Boc) and adamantyloxycarbonyl; p-methoxybenzyl carbonyl (Moz), benzyl (Bn), p-methoxybenzyl (PMB), p-methoxyphenyl (PMP), methoxyacetyl, methylamino carbonyl, methylsulfonyl, ethylsulfonyl, benzylsulfonyl, methylphosphoramidyl (MeOP(OH)(═O)) and benzylphosphoramidyl (PhCH₂OP(OH)(═O)).

The general formula of the peptide aldehyde may also be written: P-A²-A¹-L-B³—B² B¹—B⁰—H, where P, A², A¹,L, B³, B², B¹ and B⁰ are as defined above.

In the case of a tripeptide aldehyde with a protection group (i.e. x=2, L is absent and A is absent), P is preferably acetyl, methoxycarbonyl, benzyloxycarbonyl, methylamino carbonyl, methylsulfonyl, benzylsulfonyl and benzylphosphoramidyl. In the case of a tetrapeptide aldehyde with a protection group (i.e. x=3, L is absent and A is absent), P is preferably acetyl, methoxycarbonyl, methylsulfonyl, ethylsulfonyl and methylphosphoramidyl.

Suitable peptide aldehydes are described in WO94/04651, WO95/25791, WO98/13458, WO98/13459, WO98/13460, WO98/13461, WO98/13462, WO07/141736, WO07/145963, WO09/118375, WO10/055052 and WO11/036153.

More particularly, the peptide aldehyde may be
Cbz-Arg-Ala-Tyr-H (L-Alaninamide, N2-[(phenylmethoxy)carbonyl]-L-arginyl-N-[(1S)-1-formyl-2-(4-hydroxyphenyl)ethyl]-),
Ac-Gly-Ala-Tyr-H (L-Alaninamide, N-acetylglycyl-N-[(1S)-1-formyl-2-(4-hydroxyphenyl)ethyl]-)
Cbz-Gly-Ala-Tyr-H (L-Alaninamide, N-[(phenylmethoxy)carbonyl]glycyl-N-[(1S)-1-formyl-2-(4-hydroxyphenyl)ethyl]-),
Cbz-Gly-Ala-Leu-H (L-Alaninamide, N-[(phenylmethoxy)carbonyl]glycyl-N-[(1S)-1-formyl-3-methylbutyl]-),
Cbz-Val-Ala-Leu-H (L-Alaninamide, N-[(phenylmethoxy)carbonyl]-L-valyl-N-[(1S)-1-formyl-3-methylbutyl]-),
Cbz-Gly-Ala-Phe-H (L-Alaninamide, N-[(phenylmethoxy)carbonyl]glycyl-N-[(1S)-1-formyl-2-phenylethyl]-),
Cbz-Gly-Ala-Val-H (L-Alaninamide, N-[(phenylmethoxy)carbonyl]glycyl-N-[(1S)-1-formyl-2-methylpropyl]-),
Cbz-Gly-Gly-Tyr-H (Glycinamide, N-[(phenylmethoxy)carbonyl]glycyl-N-[(1S)-1-formyl-2-(4-hydroxyphenyl)ethyl]-),
Cbz-Gly-Gly-Phe-H (Glycinamide, N-[(phenylmethoxy)carbonyl]glycyl-N-[(1S)-1-formyl-2-phenylethyl]-),
Cbz-Arg-Val-Tyr-H (L-Valinamide, N2-[(phenylmethoxy)carbonyl]-L-arginyl-N-[(1S)-1-formyl-2-(4-hydroxyphenyl)ethyl]-),
Cbz-Leu-Val-Tyr-H (L-Valinamide, N-[(phenylmethoxy)carbonyl]-L-leucyl-N-[(1S)-1-formyl-2-(4-hydroxyphenyl)ethyl]-)
Ac-Leu-Gly-Ala-Tyr-H (L-Alaninamide, N-acetyl-L-leucylglycyl-N-[(1S)-1-formyl-2-(4-hydroxyphenyl)ethyl]-),
Ac-Phe-Gly-Ala-Tyr-H (L-Alaninamide, N-acetyl-L-phenylalanylglycyl-N-[(1S)-1-formyl-2-(4-hydroxyphenyl)ethyl]-),
Ac-Tyr-Gly-Ala-Tyr-H (L-Alaninamide, N-acetyl-L-tyrosylglycyl-N-[(1S)-1-formyl-2-(4-hydroxyphenyl)ethyl]-),
Ac-Phe-Gly-Ala-Leu-H (L-Alaninamide, N-acetyl-L-phenylalanylglycyl-N-[(1S)-1-formyl-3-methylbutyl]-),
Ac-Phe-Gly-Ala-Phe-H (L-Alaninamide, N-acetyl-L-phenylalanylglycyl-N-[(1S)-1-formyl-2-phenylethyl]-)
Ac-Phe-Gly-Val-Tyr-H (L-Valinamide, N-acetyl-L-phenylalanylglycyl-N-[(1S)-1-formyl-2-(4-hydroxyphenyl)ethyl]-),
Ac-Phe-Gly-Ala-Met-H (L-Alaninamide, N-acetyl-L-phenylalanylglycyl-N-[(1S)-1-formyl-3-(methylthio)propyl]-),
Ac-Trp-Leu-Val-Tyr-H (L-Valinamide, N-acetyl-L-tryptophyl-L-leucyl-N-[(1S)-1-formyl-2-(4-hydroxyphenyl)ethyl]-),
MeO—CO-Val-Ala-Leu-H (L-Alaninamide, N-(methoxycarbonyl)-L-valyl-N-[(1S)-1-formyl-3-methylbutyl]-)
MeNHCO-Val-Ala-Leu-H (L-Alaninamide, N-(aminomethylcarbonyl)-L-valyl-N-[(1S)-1-formyl-3-methylbutyl]-),
MeO—CO-Phe-Gly-Ala-Leu-H (L-Alaninamide, N-(methoxycarbonyl)-L-phenylalanylglycyl-N-[(1S)-1-formyl-3-methylbutyl]-),
MeO—CO-Phe-Gly-Ala-Phe-H (L-Alaninamide, N-(methoxycarbonyl)-L-phenylalanylglycyl-N-[(1S)-1-formyl-2-phenylethyl]-),
MeSO2-Phe-Gly-Ala-Leu-H (L-Alaninamide, N-(methylsulfonyl)-L-phenylalanylglycyl-N-[(1S)-1-formyl-3-methylbutyl]-),
MeSO2-Val-Ala-Leu-H (L-Alaninamide, N-(methylsulfonyl)-L-valyl-N-[(1S)-1-formyl-3-methylbutyl]-),
PhCH2O—P(OH)(O)-Val-Ala-Leu-H (L-Alaninamide, N-[hydroxy(phenylmethoxy)phosphinyl]-L-valyl-N-[(1S)-1-formyl-3-methylbutyl]-),
EtSO2-Phe-Gly-Ala-Leu-H (L-Alaninamide, N-(ethylsulfonyl)-L-phenylalanylglycyl-N-[(1S)-1-formyl-3-methylbutyl]-),
PhCH2SO2-Val-Ala-Leu-H (L-Alaninamide, N-[(phenylmethyl)sulfonyl]-L-yalyl-N-[(1S)-1-formyl-3-methylbutyl]-),
PhCH2O-P(OH)(O)-Leu-Ala-Leu-H (L-Alaninamide, N-[hydroxy(phenylmethoxy)phosphinyl]-L-leucyl-N-[(1S)-1-formyl-3-methylbutyl]-),
PhCH2O-P(OH)(O)-Phe-Ala-Leu-H (L-Alaninamide, N-[hydroxy(phenylmethoxy)phosphinyl]-L-phenylalanyl-N-[(1S)-1-formyl-3-methylbutyl]-), or
MeO-P(OH)(O)-Leu-Gly-Ala-Leu-H; (L-Alaninamide, N-(hydroxymethoxyphosphinyl)-L-leucylglycyl-N-[(1S)-1-formyl-3-methylbutyl]-).

A preferred example is Cbz-Gly-Ala-Tyr-H.

Further examples of such peptide aldehydes include
α-MAPI (3,5,8,11-Tetraazatridecanoic acid, 6-[3-[(aminoiminomethypamino]propyl]-12-formyl-9-(1-methylethyl)-4,7,10-trioxo-13-phenyl-2-(phenylmethyl)-, (2S,6S,9S,12S)-L-Valinamide, N2-[[(1-carboxy-2-phenylethyl)amino]carbonyl]-L-arginyl-N-(1-formyl-2-phenylethyl)-, [1(S),2(S)]-; L-Valinamide, N2-[[[(1S)-1-carboxy-2-phenylethyl]amino]carbonyl]-L-arginyl-N-[(1S)-1-formyl-2-phenylethyl]-(9Cl); SP-Chymostatin B),
β-MAPI (L-Valinamide, N2-[[[(1S)-1-carboxy-2-phenylethyl]amino]carbonyl]-L-arginyl-N-[(1R)-1-formyl-2-phenylethyl]-L-Valinamide, N2-[[(1-carboxy-2-phenylethyl)amino]carbonyl]-L-arginyl-N-(1-formyl-2-phenylethyl)-, [1(S),2(R)]-),
Phe-C(═O)-Arg-Val-Tyr-H (L-Valinamide, N2-[[[(1S)-1-carboxy-2-phenylethyl]amino]carbonyl]-L-arginyl-N-[(1S)-1-formyl-2-(4-hydroxyphenyl)ethyl]-(9Cl)),
Phe-C(═O)-Gly-Gly-Tyr-H, (3,5,8,11-Tetraazatridecanoic acid, 12-formyl-13-(4-hydroxyphenyl)-4,7,10-trioxo-2-(phenylmethyl)-, (2S,12S)-),
Phe-C(═O)-Gly-Ala-Phe-H, (3,5,8,11-Tetraazatridecanoic acid, 12-formyl-9-methyl-4,7,10-trioxo-13-phenyl-2-(phenylmethyl)-, (2S,9S,12S)-),
Phe-C(═O)-Gly-Ala-Tyr-H (3,5,8,11-Tetraazatridecanoic acid, 12-formyl-13-(4-hydroxyphenyl)-9-methyl-4,7,10-trioxo-2-(phenylmethyl)-, (2S,9S,12S)-),
Phe-C(═O)-Gly-Ala-Leu-H, (3,5,8,11-Tetraazapentadecanoic acid, 12-formyl-9,14-dimethyl-4,7,10-trioxo-2-(phenylmethyl)-, (2S,9S,12S)-),
Phe-C(═O)-Gly-Ala-Nva-H, (3,5,8,11-Tetraazapentadecanoic acid, 12-formyl-9-methyl-4,7,10-trioxo-2-(phenylmethyl)-, (2S,9S,12S)-),
Phe-C(═O)-Gly-Ala-Nle-H (3,5,8,11-Tetraazahexadecanoic acid, 12-formyl-9-methyl-4,7,10-trioxo-2-(phenylmethyl)-, (2S,9S,12S)-),
Tyr-C(═O)-Arg-Val-Tyr-H (L-Valinamide, N2-[[[(1S)-1-carboxy-2-(4-hydroxyphenyl)ethyl]amino]carbonyl]-L-arginyl-N-[(1S)-1-formyl-2-(4-hydroxyphenyl)ethyl]-(9Cl))
Tyr-C(═O)-Gly-Ala-Tyr-H (3,5,8,11-Tetraazatridecanoic acid, 12-formyl-13-(4-hydroxyphenyl)-2-[(4-hydroxyphenyl)methyl]-9-methyl-4,7,10-trioxo-, (2S,9S,12S)-)
Phe-C(=S)-Arg-Val-Phe-H, (3,5,8,11-Tetraazatridecanoic acid, 6-[3-[(aminoiminomethyl)amino]propyl]-12-formyl-9-(1-methylethyl)-7,10-dioxo-13-phenyl-2-(phenylmethyl)-4-thioxo-, (2S,6S,9S,12S)-),
Phe-C(═S)-Arg-Val-Tyr-H, (3,5,8,11-Tetraazatridecanoic acid, 6-[3-[(aminoiminomethyl)amino]propyl]-12-formyl-13-(4-hydroxyphenyl)-9-(1-methylethyl)-7,10-dioxo-2-(phenylmethyl)-4-thioxo-, (2S,6S,9S,12S)-),
Phe-C(═S)-Gly-Ala-Tyr-H, (3,5,8,11-Tetraazatridecanoic acid, 12-formyl-13-(4-hydroxyphenyl)-9-methyl-7,10-dioxo-2-(phenylmethyl)-4-thioxo-, (2S,9S,12S)-),
Antipain (L-Valinamide, N2-[[(1-carboxy-2-phenylethyl)amino]carbonyl]-L-arginyl-N-[4-[(aminoiminomethyl)amino]-1-formylbutyl]-),
GE20372A (L-Valinamide, N2-[[[(1S)-1-carboxy-2-(4-hydroxyphenyl)ethyl]amino]carbonyl]-L-arginyl-N-[(1S)-1-formyl-2-phenylethyl]-L-Valinamide, N2-[[[1-carboxy-2-(4-hydroxyphenyl)ethyl]amino]carbonyl]-L-arginyl-N-(1-formyl-2-phenylethyl)-, [1(S),2(S)]-) ,
GE20372B (L-Valinamide, N2-[[[(1S)-1-carboxy-2-(4-hydroxyphenyl)ethyl]amino]carbonyl]-L-arginyl-N-[(1R)-1-formyl-2-phenylethyl]-L-Valinamide, N2-[[[1-carboxy-2-(4-hydroxyphenypethyl]amino]carbonyl]-L-arginyl-N-(1-formyl-2-phenylethyl)-, [1(S),2(R)]-),
Chymostatin A (L-Leucinamide, (2S)-2-[(4S)-2-amino-3,4,5,6-tetrahydro-4-pyrimidinyl]-N-[[[(1S)-1-carboxy-2-phenylethyl]amino]carbonyl]glycyl-N-(1-formyl-2-phenylethyl)-L-Leucinamide, (2S)-2-[(4S)-2-amino-1,4,5,6-tetrahydro-4-pyrimidinyl]-N-[[[(1S)-1-carboxy-2-phenylethyl]amino]carbonyl]glycyl-N-(1-formyl-2-phenylethyl)-(9Cl); L-Leucinamide, L-2-(2-amino-1,4,5,6-tetrahydro-4-pyrimidinyl)-N-[[(1-carboxy-2-phenylethyl)amino]carbonyl]glycyl-N-(1-formyl-2-phenylethyl)-, stereoisomer),
Chymostatin B (L-Valinamide, (2S)-2-[(4S)-2-amino-3,4,5,6-tetrahydro-4-pyrimidinyl]-N-[[[(1S)-1-carboxy-2-phenylethyl]amino]carbonyl]glycyl-N-(1-formyl-2-phenylethyl)-L-Valinamide, (2S)-2-[(4S)-2-amino-1,4,5,6-tetrahydro-4-pyrimidinyl]-N-[[[(1S)-1-carboxy-2-phenylethyl]amino]carbonyl]glycyl-N-(1-formyl-2-phenylethyl)-(9Cl); L-Valinamide, L-2-(2-amino-1,4,5,6-tetrahydro-4-pyrimidinyl)-N-[[(1-carboxy-2-phenylethyl)amino]carbonyl]glycyl-N-(1-formyl-2-phenylethyl)-, stereoisomer), and
Chymostatin C (L-Isoleucinamide, (2S)-2-[(4S)-2-amino-3,4,5,6-tetrahydro-4-pyrimidinyl]-N-[[[(1S)-1-carboxy-2-phenylethyl]amino]carbonyl]glycyl-N-(1-formyl-2-phenylethyl)-L-Isoleucinamide, (2S)-2-[(4S)-2-amino-1,4,5,6-tetrahydro-4-pyrimidinyl]-N-[[[(1S)-1-carboxy-2-phenylethyl]amino]carbonyl]glycyl-N-(1-formyl-2-phenylethyl)-(9Cl); L-Isoleucinamide, L-2-(2-amino-1,4,5,6-tetrahydro-4-pyrimidinyl)-N-[[(1-carboxy-2-phenylethyl)amino]carbonyl]glycyl-N-(1-formyl-2-phenylethyl)-, stereoisomer).

### Peptide Aldehyde Adducts

Instead of a peptide aldehyde, the protease inhibitor may be an adduct of a peptide aldehyde. The adduct maybe a hydrosulfite adduct having the formula P-(A)_{y}-L-(B)ₓ—N(H)—CHR—CH(OH)—SO₃M, wherein P, A, y, L, B, x and R are defined as above, and M is H or an alkali metal, preferably Na or K. Alternatively, the adduct may be a hemiacetal having the formula P-(A)_{y}-L-(B)ₓ—N(H)—CHR—CH(OH)—OR, wherein P, A, y, L, B, x and R are defined as above. A preferred embodiment is a hydrosulfite adduct wherein P=Cbz, B²=Gly; B¹=Ala; B⁰=Tyr (so R=PhCH₂, R′═OH), x=2, y=0, L=A=absent and M=Na (Cbz-Gly-Ala-N(H)—CH(CH₂-p-C₆H₄OH)—CH(OH)—SO₃Na, L-Alaninamide, N-[(phenylmethoxy)carbonyl]glycyl-N-[2-hydroxy-1-[(4-hydroxyphenyl)methyl]-2-sulfoethyl]-, sodium salt (1:1)).

The general formula of the hydrosulfite adduct of a peptide aldehyde may also be written: P-A²-A¹-L-B³—B²—B¹—N(H)—CHR—CH(OH)—SO₃M, where P, A², A¹,L, B³, B², B¹, R and M are as defined above.

Alternatively, the adduct of a peptide aldehyde can be Cbz-Gly-Ala-N(H)—CH(CH₂-p-C₆H₄OH)—CH(OH)—SO₃Na (Sodium (2S)-[(N-{N-[(benzyloxy)carbonyl]glycyl}-L-alaninyl)amino]-1-hydroxy-3-(4-hydroxyphenyl)propane-1-sulfonate) or Cbz-Gly-Ala-N(H)—CH(CH2Ph)-CH(OH)—SO₃Na (Sodium (25)-[(N-{N-[(benzyloxy)carbonyl]glycyl}-L-alaninyl)amino]-1-hydroxy-3-(phenyl)propane-1-sulfonate) or “MeO—CO_Val-Ala-N(H)—CH(CH2CH(CH₃)₂)—CH(OH)—SO₃Na (Sodium (2S)-[(N-{N-[(benzyloxy)carbonyl]glycyl}-L-alaninyl)amino]-1-hydroxy-3-(2-propanyl)propane-1-sulfonate).

Other preferred peptide aldehyde bisulfites are
Cbz-Arg-Ala-NHCH(CH₂C₆H₄OH)C(OH)(SO₃M)-H where M=Na,
Ac-Gly-Ala-NHCH(CH₂C₆H₄OH)C(OH)(SO₃M)-H, where M=Na,
Cbz-Gly-Ala-NHCH(CH₂C₆H₄OH)C(OH)(SO₃M)-H, where M=Na (L-Alaninamide, N-[(phenylmethoxy)carbonyl]glycyl-N-[2-hydroxy-1-[(4-hydroxyphenyl)methyl]-2-sulfoethyl]-, sodium salt (1:1)),
Cbz-Gly-Ala-NHCH(CH₂CH(CH₃)₂))C(OH)(SO₃M)-H, where M=Na,
Cbz-Val-Ala-NHCH(CH₂CH(CH₃)₂))C(OH)(SO₃M)-H, where M=Na,
Cbz-Gly-Ala-NHCH(CH₂Ph)C(OH)(SO₃M)-H, where M=Na,
Cbz-Gly-Ala-NHCH(CH(CH₃)₂)C(OH)(SO₃M)-H, where M=Na,
Cbz-Gly-Gly-NHCH(CH₂C₆H₄OH)C(OH)(SO₃M)-H, where M=Na,
Cbz-Gly-Gly-NHCH(CH₂Ph)C(OH)(SO₃M)-H, where M=Na,
Cbz-Arg-Val-NHCH(CH₂C₆H₄OH)C(OH)(SO₃M)-H, where M=Na,
Cbz-Leu-Val-NHCH(CH₂C₆H₄OH)C(OH)(SO₃M)-H, where M=Na,
Ac-Leu-Gly-Ala-NHCH(CH₂C₆H₄OH)C(OH)(SO₃M)-H, where M=Na,
Ac-Phe-Gly-Ala-NHCH(CH₂C₆H₄OH)C(OH)(SO₃M)-H, where M=Na,
Ac-Tyr-Gly-Ala-NHCH(CH₂C₆H₄OH)C(OH)(SO₃M)-H, where M=Na,
Ac-Phe-Gly-Ala-NHCH(CH₂CH(CH₃)₂))C(OH)(SO₃M)-H, where M=Na,
Ac-Phe-Gly-Ala-NHCH(CH₂Ph)C(OH)(SO₃M)-H, where M=Na,
Ac-Phe-Gly-Val-NHCH(CH₂C₆H₄OH)C(OH)(SO₃M)-H, where M=Na,
Ac-Phe-Gly-Ala-NHCH(CH₂CH₂SCH₃)(SO₃M)-H, where M=Na,
Ac-Trp-Leu-Val-NHCH(CH₂C₆H₄OH)C(OH)(SO₃M)-H, where M=Na,
MeO—CO-Val-Ala-NHCH(CH₂CH(CH₃)₂))C(OH)(SO₃M)-H, where M=Na,
MeNCO-Val-Ala-NHCH(CH₂CH(CH₃)₂))C(OH)(SO₃M)-H, where M=Na,
MeO—CO-Phe-Gly-Ala-NHCH(CH₂CH(CH₃)₂))C(OH)(SO₃M)-H, where M=Na,
MeO—CO-Phe-Gly-Ala-NHCH(CH₂Ph)C(OH)(SO₃M)-H, where M=Na,
MeSO₂-Phe-Gly-Ala-NHCH(CH₂CH(CH₃)₂))C(OH)(SO₃M)-H, where M=Na,
MeSO₂-Val-Ala-NHCH(CH₂CH(CH₃)₂))C(OH)(SO₃M)-H, where M=Na,
PhCH₂O(OH)(O)P-Val-Ala-NHCH(CH₂CH(CH₃)₂))C(OH)(SO₃M)-H, where M=Na,
EtSO₂-Phe-Gly-Ala-NHCH(CH₂CH(CH₃)₂))C(OH)(SO₃M)-H, where M=Na,
PhCH₂SO₂-Val-Ala-NHCH(CH₂CH(CH₃)₂))C(OH)(SO₃M)-H, where M=Na,
PhCH₂O(OH)(O)P-Leu-Ala-NHCH(CH₂CH(CH₃)₂))C(OH)(SO₃M)-H, where M=Na,
PhCH₂O(OH)(O)P-Phe-Ala-NHCH(CH₂CH(CH₃)₂))C(OH)(SO₃M)-H, where M=Na,
MeO(OH)(O)P-Leu-Gly-Ala-NHCH(CH₂CH(CH₃)₂))C(OH)(SO₃M)-H, where M=Na, and
Phe-urea-Arg-Val-NHCH(CH₂C₆H₄OH)C(OH)(SO₃M)-H where M=Na.

### Salt of the Protease Inhibitor

The salt used in the liquid multi-enzyme composition is a salt of a monovalent cation and an organic anion. The monovalent cation may be for example Na⁺, K⁺ or NH₄⁺. The organic anion may be for example formate, acetate, citrate or lactate. Thus a salt of a monovalent cation and an organic anion may be, for example, sodium formate, potassium formate, ammonium formate, sodium acetate, potassium acetate, ammonium acetate, sodium lactate, potassium lactate, ammonium lactate, mono-sodium citrate, di-sodium citrate, tri-sodium citrate, sodium potassium citrate, potassium citrate, ammonium citrate or the like. A particular embodiment is sodium formate.

### Formulation of Detergent Products

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries. In one embodiment the stabilized liquid or slurry detergent additives include a selection of one or more surfactants, preferably non-ionic surfactants.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

The enzyme(s) of the detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708.

A polypeptide of the present invention may also be incorporated in the detergent formulations disclosed in WO97/07202, which is hereby incorporated by reference.

The detergent ingredients and multi-enzyme composition may be separated physically from each other by being in separate containers or compartments. Thus the negative storage interaction between components can be avoided. For example, the protease may be in one compartment as a granulate, powder, liquid or slurry, optionally together with one or more detergent components selected from the list comprising of alkalis, surfactants, hydrotropes, builders and co-builders, bleaching systems, polymers, fabric hueing agents and adjunct materials, the other enzymes are formulated as a granulate, powder, liquid or slurry and are placed in another compartment and the detergent components are placed in one or more further compartments. Alternatively, the enzymes are formulated together as a powder, granulate, liquid or slurry and are in a separate compartment to the detergent components which may be in one or more further compartments.

Different dissolution profiles of each of the ingredients can also give rise to delayed dissolution of selected components in the wash solution.

A liquid or gel detergent may be aqueous, typically containing at least 10% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

The invention is further summarized in the following paragraphs:
1. An industrial or institutional cleaning or laundering method for the cleaning or laundering of textiles and/or fabrics comprising the steps:
   (i) placing the fabrics/textile in the washing machine;
   (ii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;
   (iii) optionally washing the fabrics/textile in the wash liquor;
   (iv) adding a multi-enzyme composition during step (v) as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
   (v) washing the fabrics/textile in the wash liquor;
   (vi) optionally adding to the wash liquor one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
   (vii) draining the wash liquor;
   (viii) optionally repeating the wash cycle of steps (ii) to (vii) and draining the remaining wash liquor; and
   (ix) rinsing and optionally drying the fabrics/textiles,
with the proviso that:
   the pH of the wash liquor in step (ii) is in the range of 8-10.5 when only one wash cycle of steps (ii) to step (vii) is performed;
      the pH of the wash liquor of step (ii) is in the range of 8-10.5 in at least one of the wash cycles when the wash cycle is repeated under step (viii); and
      bleaching systems comprising chlorine or wash liquor comprising chlorine are not used in steps (ii) to (v) in at least one of the wash cycles when the wash cycle is repeated under step (viii).
2. A method according to paragraph 1, wherein the wash liquor in step (ii) is provided by dissolving surfactant, alkali and/or carbonate in water.
3. A method according to any of the preceding paragraphs, wherein the pH of the wash liquor in step (vi) is in the range of 8-13, such as in the range of 10-13.
4. An industrial or institutional cleaning or laundering method for the cleaning or laundering of textiles and/or fabrics comprising the steps:
   (i) placing the fabrics/textile in the washing machine;
   (ii) adding a multi-enzyme composition as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
   (iii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;
   (iv) washing the fabrics/textile in the wash liquor;
   (v) optionally adding one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
   (vi) draining the wash liquor;
   (vii) optionally repeating the wash cycle of steps (ii) to (vi); and
   (viii) rinsing and optionally drying the fabrics/textiles; .
with the proviso that:
   the pH of the wash liquor in step (iii) is in the range of 8-10.5 when only one wash cycle of steps (ii) to step (vi) is performed;
      the pH of the wash liquor of step (iii) is in the range of 8-10.5 in at least one of the wash cycles when the wash cycle is repeated under step (viii); and
      bleaching systems comprising chlorine or wash liquor comprising chlorine are not used in steps (ii) to (v) in at least one of the wash cycles when the wash cycle is repeated under step (viii).
5. A method according to paragraph 4, wherein the wash liqueur in step (iii) is provided by dissolving surfactant, alkali and/or carbonate in water.
6. A method according to paragraphs 4-5, wherein the pH of the wash liquor in step (vi) is in the range of 8-13, such as in the range of 10-13.
7. The method according to any of the preceding paragraphs, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.
8. The method according to any of the preceding paragraphs,wherein the multi-enzyme composition comprises one or more proteases, one or more amylases and optionally one or more enzymes selected among lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.
9. The method according to any of the preceding paragraphs, wherein the multi-enzyme composition comprises one or more proteases, one or more cellulases and optionally one or more enzymes selected among amylases, lipases, cutinases, acyltransferases, endoglucanases, xyloglucanases, mannanases, arabinases, galactanases, pectinases, pectate lyases, xanthanases, xanthan lyases, xylanases, laccases and/or peroxidases.
10. The method according to any of the preceding paragraphs, wherein each protease is independently selected from the group consisting of:
   (a) a polypeptide having at least 90%, such as at least 95%, sequence identity to SEQ ID NO: 1;
   (b) a polypeptide having at least 90%, such as at least 95%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
   (c) a polypeptide having at least 90%, such as at least 95%, sequence identity to SEQ ID NO: 2;
   (d) a polypeptide having at least 90%, such as at least 95%, sequence identity SEQ ID NO: 2 or a variant thereof wherein the polypeptide comprises a substitution in one or more of positions: 3, 4, 99, 101, 103, 104, 159, 194, 199, 205 and/or 217; and
   (e) a polypeptide having at least 90%, such as at least 95%, sequence identity SEQ ID NO: 23.
11. The method according to any of the preceding paragraphs, wherein each amylase is independently selected from the group consisting of:
   (a) a polypeptide having at least 90%, such as at least 95%, sequence identity to SEQ ID NO: 3;
   (b) a polypeptide having at least 90%, such as at least 95%, sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
   (c) a polypeptide having at least 90%, such as at least 95%, sequence identity to SEQ ID NO: 4
   (d) a polypeptide having at least 90%, such as at least 95%, sequence identity to the hybrid polypeptide of SEQ ID NO: 5
   (e) a polypeptide having at least 90%, such as at least 95%, sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
   (f) a polypeptide having at least 90%, such as at least 95%, sequence identity to SEQ ID NO: 6;
   (g) a polypeptide having at least 90%, such as at least 95%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
   (h) a polypeptide having at least 90%, such as at least 95%, sequence identity to SEQ ID NO: 7, SEQ ID NO: 8 or SEQ ID NO: 9;
   (i) a polypeptide having at least 90%, such as at least 95%, sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184 195, 206, 243, 260, 304 and/or 476;
   (j) a polypeptide having at least 90%, such as at least 95%, sequence identity to SEQ ID NO: 10;
   (k) a polypeptide having at least 90%, such as at least 95%, sequence identity to SEQ ID NO: 11;
   (l) a polypeptide having at least 90%, such as at least 95%, sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
   (m) a polypeptide having at least 90%, such as at least 95%, sequence identity to SEQ ID NO: 12;
   (n) a polypeptide having at least 90%, such as at least 95%, sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
   (o) a polypeptide having at least 90%, such as at least 95%, sequence identity to SEQ ID NO: 13; and
   (p) a polypeptide having at least 90%, such as at least 95%, sequence identity to SEQ ID NO: 13 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484.
12. The method according to any of the preceding paragraphs, wherein each cellulase is independently selected from the group consisting of:
   (a) a polypeptide having at least 90%, such as at least 95%, sequence identity to the amino acid sequence of position 1 to position 773 of SEQ ID NO:14; and
   (b) a polypeptide having at least 80%, such as at least 85%, such as at least 90%, such as at least 95% sequence identity to SEQ ID NO: 15; and
   (c) a polypeptide having at least 80%, such as at least 85%, such as at least 90%, such as at least 95% sequence identity to SEQ ID NO: 15 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
   (d) a polypeptide having at least 80%, such as at least 85%, such as at least 90%, such as at least 95% sequence identity to SEQ ID NO: 22.
13. The method according to any of the preceding paragraphs, wherein each lipase is independently selected from the group consisting of:
   (a) a polypeptide having at least 90%, such as at least 95%, sequence identity to SEQ ID NO: 16;
   (b) a polypeptide having at least 90%, such as at least 95%, sequence identity to SEQ ID NO: 16 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
   (c) a polypeptide having at least 90%, such as at least 95%, sequence identity to SEQ ID NO: 16 or a variant thereof wherein the polypeptide comprises the following substitutions T231R and N233R.
14. The method according to any of the preceding paragraphs, wherein each pectate lyase is independently selected from the group consisting of:
   (a) a polypeptide having at least 80%, such as at least 85%, at least 90%, or at least 95% sequence identity to SEQ ID NO: 17; and
   (b) a polypeptide having at least 80%, such as at least 85%, at least 90%, or at least 95% sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397.
15. The method according to any of the preceding paragraphs, wherein each mannanase is independently selected from the group consisting of:
   (a) a polypeptide having at least 80%, such as at least 85%, at least 90%, or at least 95% sequence identity to amino acids 31 to 330 of SEQ ID NO: 18;
   (b) a polypeptide having at least 80%, such as at least 85%, at least 90%, or at least 95% sequence identity to amino acids 32 to 334 of SEQ ID NO: 19;
   (c) a polypeptide having at least 80%, such as at least 85%, at least 90%, or at least 95% sequence identity to amino acids 33 to 331 of SEQ ID NO: 20; and
   (d) a polypeptide having at least 80%, such as at least 85%, at least 90%, or at least 95% sequence identity to amino acids 68 to 369 of SEQ ID NO: 21.
16. The method according to any of the preceding paragraphs, wherein the amount of each enzyme added per wash cycle corresponds to 0.0001-500 mg of enzyme protein per kilogram of dry textile, preferably 0.001-200 mg of enzyme protein, more preferably 0.01-100 mg of enzyme protein, even more preferably 0.05-50 mg of enzyme protein and most preferably 0.2-20 mg of enzyme protein per kilogram of dry textile.
17. The method according to any of the preceding paragraphs, wherein the multi-enzyme composition gives improved cleaning benefits such as improved wash performance and/or improved enzyme detergency benefits.
18. The method according to any of the preceding paragraphs, wherein the maximum wash temperature is reduced whilst at the same time obtaining equal or improved cleaning benefits such as improved wash performance and/or enzyme detergency benefits when compared to the method where the maximum wash temperature is not reduced and a multi-enzyme composition is not used.
19. The method according to any of the preceding paragraphs, wherein the washing time is reduced whilst at the same time obtaining equal or improved cleaning benefits such as improved wash performance and/or enzyme detergency benefits compared to the method where the washing time is not reduced and a multi-enzyme composition is not used.
20. The method according to any of the preceding paragraphs, wherein the amount of detergent components is reduced whilst at the same time obtaining equal or improved cleaning benefits such as improved wash performance and/or enzyme detergency benefits compared to the method where the amount of detergent components is not reduced and a multi-enzyme composition is not used.
21. The method according to any of the preceding paragraphs, wherein the wash liquor is only partly drained and the remainder of the wash liquor is used as wash liquor during a second or third wash cycle, optionally with new supply of water.
22. The method according to any of the preceding paragraphs, wherein the pH of the wash liquor is in the range of 7-10.5, in the range of 8-10.5, in the range of 8.5-9.5, in the range of 9-9.5, in the range of 9-11, in the range of 9.5-10.5, in the range of 10-11 or in the range of 10.5-11.
23. The method according to any of the preceding paragraphs, wherein the pH of the wash liquor during a first wash cycle is in the range of 7-10.5, in the range of 8-10.5, in the range of 8.5-9.5, in the range of 9-9.5 or in the range of 9.5-10.5.
24. The method according to any of the preceding paragraphs, wherein the pH of the wash liquor during a second or third wash cycle is in the range of 9-11, in the range of 10-11, in the range of 11-12, in the range of 12-13 or in the range of 11.5-12.5.
25. The method according to any of the preceding paragraphs, wherein the bleaching system comprises hydrogen peroxide, preformed peracids and mixtures thereof.
26. The method according to any of the preceding paragraphs, wherein the peracids is selected from the group consisting of 6-(phthalimido)peroxy hexanoic acid (PAP), peroxycarboxylic acids and salts, percarbonic acids and salts, perimidic acids and salts, peroxymonosulfuric acids and salts and mixtures thereof.
27. The method according to any of the preceding paragraphs, wherein the method is performed in a tunnel washer (continues batch washer).
28. The method according to any of the preceding paragraphs, wherein the multi-enzyme composition comprises:
   a) a protease having at least 90%, such as at least 95%, sequence identity to SEQ ID NO: 1;
   b) an amylase having at least 90%, such as at least 95%, sequence identity to SEQ ID NO: 11;
   c) a polypeptide having at least 80%, such as at least 85%, such as at least 90%, such as at least 95% sequence identity to SEQ ID NO: 15;
   d) a cellulase having at least 90%, such as at least 95%, sequence identity to the amino acid sequence of position 1 to position 773 of SEQ ID NO:14 or a cellulase having at least 80%, such as at least 85%, such as at least 90%, such as at least 95% sequence identity to SEQ ID NO: 22;
   e) a lipase having at least 90%, such as at least 95%, sequence identity to SEQ ID NO: 16 or a variant thereof wherein the polypeptide comprises the following substitutions T231R and N233R;
   f) a pectate lyase having at least 80%, such as at least 85%, at least 90%, or at least 95% sequence identity to SEQ ID NO: 17; and
   g) a mannanase having at least 80%, such as at least 85%, at least 90%, or at least 95% sequence identity to amino acids 31 to 330 of SEQ ID NO: 18.
29. The method according to any of the preceding paragraphs, wherein from 0.1 to 2.0 g of a granulate multi-enzyme composition per kg dry textile is used in the method, wherein the composition comprises:
   a) 35-45 w % granulates of a protease having at least 90%, such as at least 95%, sequence identity to SEQ ID NO: 1;
   b) 8-18 wt % granulates of an amylase having at least 90%, such as at least 95%, sequence identity to SEQ ID NO: 11;
   c) 2.5-5.5 wt % granulates of a polypeptide having at least 80%, such as at least 85%, such as at least 90%, such as at least 95% sequence identity to SEQ ID NO: 15;
   d) 7.5-12.5 wt % granulates of a a cellulase having at least 90%, such as at least 95%, sequence identity to the amino acid sequence of position 1 to position 773 of SEQ ID NO:14
   e) 6-11 wt % granulates of a lipase having at least 90%, such as at least 95%, sequence identity to SEQ ID NO: 16 or a variant thereof wherein the polypeptide comprises the following substitutions T231 R and N233R;
   f) 7.5-12.5 wt % granulates of a pectate lyase having at least 80%, such as at least 85%, at least 90%, or at least 95% sequence identity to SEQ ID NO: 17; and
   g) 7.5-12.5 wt % granulates of a mannanase having at least 80%, such as at least 85%, at least 90%, or at least 95% sequence identity to amino acids 31 to 330 of SEQ ID NO: 18.
30. The method according to any of the preceding paragraphs, wherein 0.5 g of a granulate multi-enzyme composition per kg dry textile is used in the method, wherein the composition comprises:
   a) 41.3 wt % granulates of a protease having at least 90%, such as at least 95%, sequence identity to SEQ ID NO: 1;
   b) 13.3 wt % granulates of an amylase having at least 90%, such as at least 95%, sequence identity to SEQ ID NO: 11;
   c) 4.7 wt % granulates of a polypeptide having at least 80%, such as at least 85%, such as at least 90%, such as at least 95% sequence identity to SEQ ID NO: 15;
   d) 10.7 wt % granulates of a a cellulase having at least 90%, such as at least 95%, sequence identity to the amino acid sequence of position 1 to position 773 of SEQ ID NO:14
   e) 8.7 wt % granulates of a lipase having at least 90%, such as at least 95%, sequence identity to SEQ ID NO: 16 or a variant thereof wherein the polypeptide comprises the following substitutions T231 R and N233R;
   f) 10.7 wt % granulates of a pectate lyase having at least 80%, such as at least 85%, at least 90%, or at least 95% sequence identity to SEQ ID NO: 17; and
   g) 10.7 wt % granulates of a mannanase having at least 80%, such as at least 85%, at least 90%, or at least 95% sequence identity to amino acids 31 to 330 of SEQ ID NO: 18.
31. The method according to any of paragraph 28-30, wherein the multi-enzyme composition further comprises a polypeptide having at least 90%, such as at least 95%, sequence identity to the amino acid sequence of position 1 to position 773 of SEQ ID NO:14.
32. The method according to any of paragraphs 1-27, wherein the multi-enzyme composition comprises:
   a) a polypeptide having at least 90%, such as at least 95%, sequence identity SEQ ID NO: 23;
   b) a polypeptide having at least 90%, such as at least 95%, sequence identity to SEQ ID NO: 16 or a variant thereof wherein the polypeptide comprises the following substitutions T231 R and N233R; and
   c) a polypeptide having at least 90%, such as at least 95%, sequence identity to SEQ ID NO: 6;
33. The method according to any of paragraphs 1-27 and 32, wherein 0.1 to 6.0 g of a liquid multi-enzyme composition per kg dry textile is added, wherein the multi-enzyme composition comprises:
   a) a protease in a concentration affording an activity of 1.0-2.0 KNPU(S)/g, having at least 90%, such as at least 95%, sequence identity to SEQ ID NO: 1;
   b) an amylase in a concentration affording an activity of 0.15-0.50 SNU/g, having at least 90%, such as at least 95%, sequence identity to SEQ ID NO: 11;
   c) a polypeptide in a concentration affording an activity of 50-100 CNU(R)/g, having at least 80%, such as at least 85%, such as at least 90%, such as at least 95% sequence identity to SEQ ID NO: 15;
   d) a cellulase in a concentration affording an activity of 30-80 ECU/g, having at least 90%, such as at least 95%, sequence identity to the amino acid sequence of position 1 to position 773 of SEQ ID NO:22;
   e) a lipase in a concentration affording an activity of 2.0-4.0 KLU/g, having at least 90%, such as at least 95%, sequence identity to SEQ ID NO: 16 or a variant thereof wherein the polypeptide comprises the following substitutions T231 R and N233R;
   f) a pectate lyase in a concentration affording an activity of 9.0-16.0 PDEU/g, having at least 80%, such as at least 85%, at least 90%, or at least 95% sequence identity to SEQ ID NO: 17; and
   g) a mannanase in a concentration affording an activity of 0.025-0.075 MIU/g, having at least 80%, such as at least 85%, at least 90%, or at least 95% sequence identity to amino acids 31 to 330 of SEQ ID NO: 18.
34. The method according to any of paragraphs 1-27 and 32-33, wherein 2.0 g of a liquid multi-enzyme composition per kg dry textile is added, wherein the multi-enzyme composition comprises:
   a) a protease in a concentration affording an activity of 1.5 KNPU(S)/g, having at least 90%, such as at least 95%, sequence identity to SEQ ID NO: 1;
   b) an amylase in a concentration affording an activity of 0.30 SNU/g, having at least 90%, such as at least 95%, sequence identity to SEQ ID NO: 11;
   c) a polypeptide in a concentration affording an activity of 72.4 CNU(R)/g, having at least 80%, such as at least 85%, such as at least 90%, such as at least 95% sequence identity to SEQ ID NO: 15;
   d) a cellulase in a concentration affording an activity of 53.6 ECU/g, having at least 90%, such as at least 95%, sequence identity to the amino acid sequence of position 1 to position 773 of SEQ ID NO:22;
   e) a lipase in a concentration affording an activity of 2.7 KLU/g, having at least 90%, such as at least 95%, sequence identity to SEQ ID NO: 16 or a variant thereof wherein the polypeptide comprises the following substitutions T231 R and N233R;
   f) a pectate lyase in a concentration affording an activity of 13.4 PDEU/g, having at least 80%, such as at least 85%, at least 90%, or at least 95% sequence identity to SEQ ID NO: 17; and
   g) a mannanase in a concentration affording an activity of 0.050 MIU/g, having at least 80%, such as at least 85%, at least 90%, or at least 95% sequence identity to amino acids 31 to 330 of SEQ ID NO: 18.
35. The method according to any of the preceding paragraphs, wherein a washing step is carried out between step (i) and step (ii), wherein the pH of the wash liquor is in the range of 8-13, such as 10-13.
36. Use of a multi-enzyme composition for improving wash performance, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.
37. Use according to paragraph 36, wherein the remission value is at least 2 remission units higher than when compared to a similar washing method where the maximum wash temperature is not reduced and a multi-enzyme composition is not used.
38. Use according to any of the preceding use paragraphs, wherein the remission value is at least 3 remission units higher, at least 4 remission units higher, at least 4 remission units higher, at least 5 remission units higher, at least 6 remission units higher, at least 7 remission units higher, at least 8 remission units higher, at least 9 remission units higher, at least 10 remission units higher, at least 11 remission units higher, at least 12 remission units higher, at least 13 remission units higher, at least 14 remission units higher, at least 15 remission units higher, at least 16 remission units higher, at least 17 remission units higher, at least 18 remission units higher, at least 19 remission units higher or at least 20 remission units higher.
39. Use according to any of the preceding use paragraphs, wherein the wash temperature is reduced whilst at the same time obtaining equal or wash performance.
40. Use any of the preceding use paragraphs, wherein the washing time is reduced whilst at the same time obtaining equal or improved wash performance compared to the method where the washing time is not reduced and a multi-enzyme composition is not used.
41. Use according to any of the preceding use paragraphs, wherein the amount of detergent components is reduced whilst at the same time obtaining equal or improved wash performance compared to the method where the amount of detergent components is not reduced and a multi-enzyme composition is not used.
42. Use of a multi-enzyme composition for reducing the number of re-washes, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.
43. Use according to paragraph 42, wherein the number of re-washes is reduced by at least 5%.
44. Use of a multi-enzyme composition for increasing the life-time of a textile, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.

And the invention is summarized in the below paragraphs:
1a. A method for the cleaning or laundering of textiles and/or fabrics comprising the steps:
   (i) placing the fabrics/textile in the washing machine;
   (ii) providing a wash liquor by dissolving/mixing one or more detergent components, selected from the list comprising of alkalis, surfactants, hydrotropes, builders and co-builders, bleaching systems, polymers, fabric hueing agents and/or adjunct materials, in water;
   (iii) optionally washing the fabrics/textile in the wash liquor;
   (iv) adding a multi-enzyme composition as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
   (v) washing the fabrics/textile in the wash liquor;
   (vi) optionally adding one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
   (vii) draining the wash liquor and optionally repeating the wash cycle; and
   (viii) rinsing and optionally drying the fabrics/textiles.
2a. A method for the cleaning or laundering of textiles and/or fabrics comprising the steps:
   (i) placing the fabrics/textile in the washing machine;
   (ii) adding a multi-enzyme composition as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
   (iii) providing a wash liquor by dissolving/mixing one or more detergent components, selected from the list comprising of alkalis, surfactants, hydrotropes, builders and co-builders, bleaching systems, polymers, fabric hueing agents and/or adjunct materials, in water;
   (iv) washing the fabrics/textile in the wash liquor;
   (v) optionally adding one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
   (vi) draining the wash liquor and optionally repeating the wash cycle; and
   (vii) rinsing and optionally drying the fabrics/textiles.
3a. The method of any of the paragraphs la-2a, wherein the multi-enzyme composition comprises two or more enzymes selected among proteases, amylases, lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.
4a. The method of any of paragraphs 1a-3a wherein the multi-enzyme composition comprises one or more proteases, one or more amylases and optionally one or more enzymes selected among lipases, cellulases, cutinases, acyltransferases, endoglucanases, xyloglucanases, mannanases, arabinases, galactanases, pectinases, pectate lyases, xanthanases, xanthan lyases, xylanases, laccases and/or peroxidases.
5a. The method of any of paragraphs 1a-3a wherein the multi-enzyme composition comprises one or more proteases, one or more cellulases and optionally one or more enzymes selected among amylases, lipases, cutinases, acyltransferases, endoglucanases, xyloglucanases, mannanases, arabinases, galactanases, pectinases, pectate lyases, xanthanases, xanthan lyases, xylanases, laccases and/or peroxidases.
6a. The method of any of paragraphs 3a-5a, wherein each protease is independently selected from the group consisting of:
   (a) a polypeptide having at least 90%, such as at least 95%, sequence identity to SEQ ID NO: 4 of WO 03/006602;
   (b) a polypeptide having at least 90%, such as at least 95%, sequence identity to SEQ ID NO: 4 of WO 03/006602 12307 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
   (c) a polypeptide having at least 90%, such as at least 95%, sequence identity to the amino acid sequence shown in FIG. 29 of U.S. Pat. No. 5,352,604; and
   (d) a polypeptide having at least 90%, such as at least 95%, sequence identity to the amino acid sequence shown in FIG. 29 of U.S. Pat. No. 5,352,604 12307 or a variant thereof wherein the polypeptide comprises a substitution in one or more of positions: 3, 4, 99, 101, 103, 104, 159, 194, 199, 205 and/or 217.
7a. The method of any of paragraphs 3a-5a, wherein each amylase is independently selected from the group consisting of:
   (a) a polypeptide having at least 90%, such as at least 95%, sequence identity to SEQ ID NO: 3 of WO 95/10603;
   (b) a polypeptide having at least 90%, such as at least 95%, sequence identity to SEQ ID NO: 3 in WO 95/10603 12307 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
   (c) a polypeptide having at least 90%, such as at least 95%, sequence identity to SEQ ID NO: 6 in WO 02/010355;
   (d) a polypeptide having at least 90%, such as at least 95%, sequence identity to the hybrid polypeptide comprising residues 1-33 of SEQ ID NO: 6 of WO 2006/066594 and residues 36-483 of SEQ ID NO: 4 of WO 2006/066594;
   (e) a polypeptide having at least 90%, such as at least 95%, sequence identity to the hybrid polypeptide comprising residues 1-33 of SEQ ID NO: 6 of WO 2006/066594 and residues 36-483 of SEQ ID NO: 4 of WO 2006/066594 wherein the hybrid polypeptide comprises a substitution, a deletion or an insertion in one of more of positions: 48, 49, 107, 156, 181, 190, 197, 201, 209 and/or 264;
   (f) a polypeptide having at least 90%, such as at least 95%, sequence identity to SEQ ID NO: 6 of WO 02/019467;
   (g) a polypeptide having at least 90%, such as at least 95%, sequence identity to SEQ ID NO: 6 of WO 02/019467 12307 or a variant thereof wherein the polypeptide comprises a substitution, a deletion or an insertion in one of more of positions: 181, 182, 183, 184, 195, 206, 212, 216 and/or 269;
   (h) a polypeptide having at least 90%, such as at least 95%, sequence identity to SEQ ID NO: 1, SEQ ID NO: 2 or SEQ ID NO: 7 of WO 96/023873
   (i) a polypeptide having at least 90%, such as at least 95%, sequence identity to SEQ ID NO: 1, SEQ ID NO: 2 or SEQ ID NO: 7 of WO 96/023873 12307 or a variant thereof wherein the polypeptide comprises a substitution, a deletion or an insertion in one of more of positions: 140, 183, 184 195, 206, 243, 260, 304 and/or 476;
   (j) a polypeptide having at least 90%, such as at least 95%, sequence identity to SEQ ID NO: 2 of WO 08/153815;
   (k) a polypeptide having at least 90%, such as at least 95%, sequence identity to SEQ ID NO: 10 of WO 01/66712;
   (l) a polypeptide having at least 90%, such as at least 95%, sequence identity to SEQ ID NO: 10 of WO 01/66712 12307 or a variant thereof wherein the polypeptide comprises a substitution, a deletion or an insertion in one of more of positions: 176, 177, 178, 179, 190, 201, 207, 211 and/or 264;
   (m) a polypeptide having at least 90%, such as at least 95%, sequence identity to SEQ ID NO: 2 of WO 09/061380;
   (n) a polypeptide having at least 90%, such as at least 95%, sequence identity to SEQ ID NO: 2 of WO 09/061380 12307 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
   (o) a polypeptide having at least 90%, such as at least 95%, sequence identity to SEQ ID NO: 12 of WO 01/66712; and
   (p) a polypeptide having at least 90%, such as at least 95%, sequence identity to SEQ ID NO: 12 of WO 01/66712 12307 or a variant thereof wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484.
8a. The method of any of paragraphs 3a-5a, wherein each cellulase is independently selected from the group consisting of:
   (a) a polypeptide having at least 90%, such as at least 95%, sequence identity to the amino acid sequence of position 1 to position 773 of SEQ ID NO:2 in WO02/099091; and
   (b) a polypeptide having at least 80%, such as at least 85%, such as at least 90%, such as at least 95% sequence identity to SEQ ID NO: 5 of WO98/12307; and
   (c) a polypeptide having at least 80%, such as at least 85%, such as at least 90%, such as at least 95% sequence identity to SEQ ID NO: 5 of WO98/12307 or a variant thereof wherein the polypeptide comprises a substitution, a deletion or an insertion in one of more of positions: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;
9a. The method of any of paragraphs 3a-5a, wherein each lipase is independently selected from the group consisting of:
   (a) a polypeptide having at least 90%, such as at least 95%, sequence identity to SEQ ID NO: 2 of WO07/87508;
   (b) a polypeptide having at least 90%, such as at least 95%, sequence identity to SEQ ID NO: 2 of W007/87508 12307 or a variant thereof wherein the polypeptide comprises a substitution, a deletion or an insertion in one of more of positions: 4, 24, 27, 33, 57, 58, 60, 62, 81, 83, 84, 86, 87, 90, 91, 94, 96, 99, 101, 102, 147, 150, 190, 202, 209, 210, 211, 227, 231, 233, 249, 255, 256, 270, 271 and 272;
10a. The method of any of paragraphs 3a-5a, wherein each pectate lyase is independently selected from the group consisting of:
   (a) a polypeptide having at least 80%, such as at least 85%, at least 90%, or at least 95% sequence identity to SEQ ID NO: 2 of WO2003/095638; and
   (b) a polypeptide having at least 80%, such as at least 85%, at least 90%, or at least 95% sequence identity to SEQ ID NO: 2 of WO2003/095638 12307 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397.
11a. The method of any of paragraphs 3a-5a, wherein each mannanase is independently selected from the group consisting of:
   (a) a polypeptide having at least 80%, such as at least 85%, at least 90%, or at least 95% sequence identity to amino acids 31 to 330 of SEQ ID NO: 2 of WO 99/64619;
   (b) a polypeptide having at least 80%, such as at least 85%, at least 90%, or at least 95% sequence identity to amino acids 32 to 334 of SEQ ID NO: 6 of WO 99/64619;
   (c) a polypeptide having at least 80%, such as at least 85%, at least 90%, or at least 95% sequence identity to amino acids 33 to 331 of SEQ ID NO: 12 of WO 99/64619; and
   (d) a polypeptide having at least 80%, such as at least 85%, at least 90%, or at least 95% sequence identity to amino acids 68 to 369 of SEQ ID NO: 16 of WO 99/64619.
12a. The method of any of paragraphs 1a-11a, wherein the amount of each enzyme added per wash cycle corresponds to 0.0001-500 mg of enzyme protein per kilogram of dry textile, preferably 0.001-200 mg of enzyme protein, more preferably 0.01-100 mg of enzyme protein, even more preferably 0.05-50 mg of enzyme protein and most preferably 0.2-20 mg of enzyme protein per kilogram of dry textile.
13a. The method of any of paragraphs 1a-12a, wherein the multi-enzyme composition gives improved cleaning benefits such as improved wash performance and/or improved enzyme detergency benefits.
14a. The method of any of paragraphs la-13a, wherein the maximum wash temperature is reduced whilst at the same time obtaining equal or improved cleaning benefits such as improved wash performance and/or enzyme detergency benefits when compared to the method where the maximum wash temperature is not reduced and a multi-enzyme composition is not used.
15a. The method of any of paragraphs 1a-14a, wherein the washing time is reduced whilst at the same time obtaining equal or improved cleaning benefits such as improved wash performance and/or enzyme detergency benefits compared to the method where the washing time is not reduced and a multi-enzyme composition is not used.
16a. The method of any of paragraphs 1a-15a, wherein the amount of detergent components is reduced whilst at the same time obtaining equal or improved cleaning benefits such as improved wash performance and/or enzyme detergency benefits compared to the method where the amount of detergent components is not reduced and a multi-enzyme composition is not used.

### EXAMPLES

### Materials and Methods

Test swatches

The following test swatches were used in the experiments: CFT C-S-28 Corn starch and pigment; WFK 20 PF Vegetable fat; CFT C-S-06 Salad dressing; EMPA 116 Blood, Milk, Carbon; EMPA 114 Red wine; CFT KC-H097 Cacao/Oat flakes; CFT C-S-32 Sebum; and EMPA 165 Chocolate Pudding, all purchased from Center For Testmaterials (CFT), The Netherlands. In addition the following two test swatches purchased from Warwick Equest, Consett, County Durham, United Kingdom were also used: Equest 123-KC Tomato Puree; and Equest P01 KC Tangerine.

Measuring of test swatches

After line drying the remission values of the test swatches were measured 2 times on each swatch using a Color-Eye 7000 A (CE7000) from Gretagmacbeth (now X-rite) in reflection mode, excluding UV. D65 Daylight was used and remissions collected at 460 nm, CIE Lab.

### Example 1

Evaluation of Wash Performance by Using Test Swatches in Field Trial Conditions

This trial was conducted to evaluate the wash performance of a multi-enzyme composition.

Detergent Composition Components:

All detergent composition components used are available from Ecolab ApS, Valby, Denmark and are defined below.

Multi-Enzyme Composition:

The multi-enzyme composition consisted of a mixture of commercial enzymes, all available from Novozymes NS, Bagsvaerd, Denmark, and is shown in Table 1 below.

TABLE 1
Multi-Enzyme Composition

| Enzymes in multi-enzyme composition | Weight % |
|---|---|
| Savinase 16 T | 41.3 |
| Stainzyme Plus 12 T | 13.3 |
| Lipex 100 T | 8.7 |
| Mannaway 4 T | 10.7 |
| Celluclean 4500 T | 10.7 |
| Carezyme Premium 5000 T | 4.7 |
| (Renozyme 5000 T) | |
| Xpect 1000 T | 10.7 |

Soiled kitchen uniforms were washed in 2 different programs, a normal program and a milder program where a multi-enzyme composition was included. Firstthe wash performance of the multi-enzyme composition was evaluated by comparing sets of standard test swatches after they had been washed together with the soiled kitchen uniforms in either the normal or the milder kitchen uniform wash program. The milder program A had a shorter washing time, a lower washing temperature and less of the detergent composition (significantly less non-ionic surfactants and harsh potassium hydroxide) when compared to the normal program B. The two different programs are described in more detail in table 2 below.

TABLE 2
Description of the two different washing programs used

| | Milder program A | Normal program B |
|---|---|---|
| Parameters | with enzymes | without* enzymes |
| Total washing time | 47 min | 70 min |
| Prewash - time, temperature | 8 min, 35° C. | 13 min, 35° C. |
| Mainwash - time, temperature | 17 min, 60° C. | 23 min, 70° C. |
| Rinse time | 5 min | 8 min |
| Detergent composition components | [g/kg dry textile] | [g/kg dry textile] |
| Dermasil Protein (protease) | 2 | 3 |
| Ozonit Performance (H₂O₂ about 8-35%, | 4 | 4 |
| acetic acid about 25-90%, peracetic | | |
| acid about 10-25%) | | |
| Pro Parol (NaOH 25-35%) | 6 | 6 |
| Triplex Plus M (fatty alcohol ethoxylate =/< | 5 | 7 |
| c15 en =/< 5EO about 50-75%, fatty alcohol | | |
| ethoxylate =/< c15 en =/< 5EO about | | |
| 10-20%, ethanol about 2-10%) | | |
| Triplex Emulsion M (KOH about 7-25%, | 16 | 25 |
| fatty alcohol ethoxylate =/< c15 en =/< | | |
| 5EO 5-10%, fatty alcohol ethoxylate =/< | | |
| c15 en =/< 5EO about 5-7%, sodium car- | | |
| bonate about 1-5%, phoshonate about 1-5%, | | |
| Sodium cumenesulfonate about 1-5%) | | |
| Turbo Finale NR (softener, neutralizer) | 3 | 2 |
| Multi-enzyme composition | 0.50 | — |

*The detergent composition for program B did contain a protease (Dermasil Protein)

One of each of the 10 test swatches used (Table 3) was attached to each of 12 tea towels. A two-chamber 60 kg industrial washer extractor (Pharmagg FA 600) was loaded with soiled kitchen uniforms, and two tea towels with swatches were added, one in each chamber. For the normal kitchen uniform program the machine was started and run as normal—this was done 3 times in total. For the milder program the multi-enzyme composition was added as a mix of granulates (0.50 g per kg dry textile) directly into one of the chambers, whereupon the machine was started—this was also done 3 times in total.

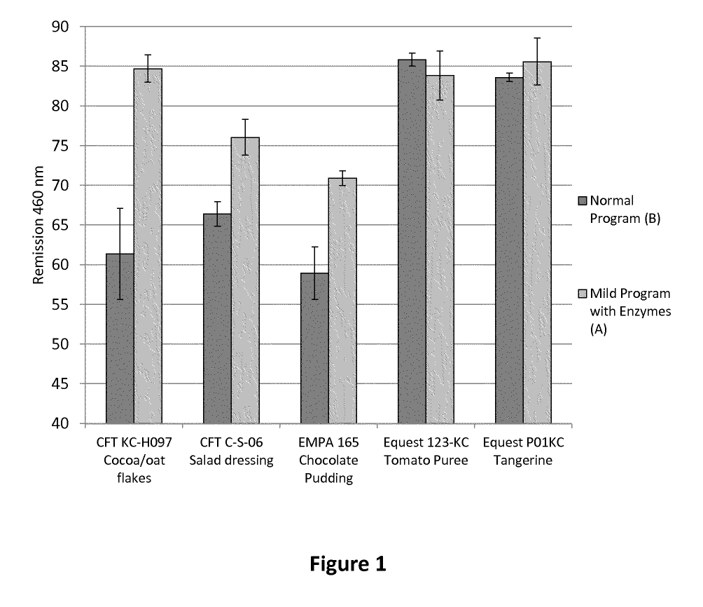

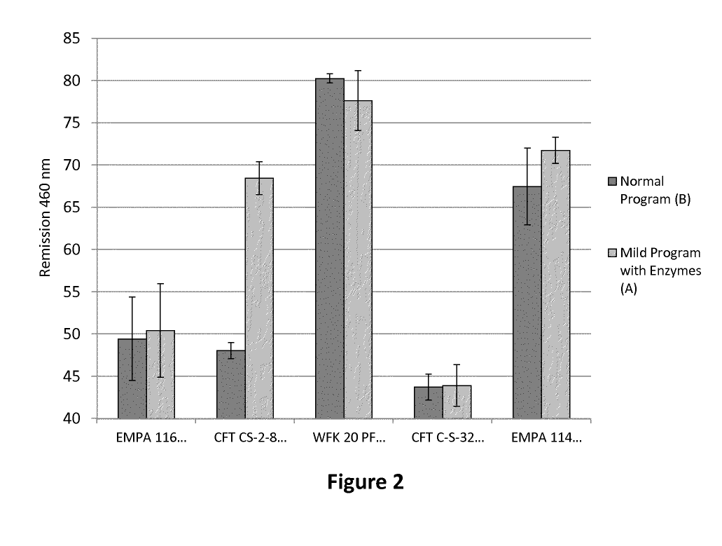

After washing, the tea towels were line dried and the swatches measured. Average remission values REM for swatches washed under same conditions are listed in Table 3 below and can as well be seen in FIG. 1.

TABLE 3
Average Remission Values of Various standard test swatches

| | Milder program A | | Normal program B | |
|---|---|---|---|---|
| | with enzymes | | without* enzymes | |
| Stain | REM | Std. Dev. | REM | Std. Dev. |
| CFT C-S-28 Corn starch | 68.4 | 2.0 | 48.0 | 1.0 |
| and pigment | | | | |
| WFK 20 PF Vegetable fat | 77.6 | 3.6 | 80.2 | 0.5 |
| CFT C-S-06 Salad dressing | 76.1 | 2.2 | 66.4 | 1.5 |
| EMPA 116 Blood. Milk. Carbon | 50.4 | 5.5 | 49.4 | 4.9 |
| EMPA 114 Red wine | 71.7 | 1.6 | 67.5 | 4.5 |
| CFT KC-H097 Cacao/Oat flakes | 84.7 | 1.7 | 61.4 | 5.7 |
| CFT C-S-32 Sebum | 43.9 | 2.5 | 43.7 | 1.5 |
| EMPA 165 Chocolate Pudding | 70.9 | 0.9 | 58.9 | 3.3 |
| Equest 123-KC Tomato Puree | 83.8 | 3.1 | 85.8 | 0.8 |
| Equest P01 KC Tangerine | 85.6 | 3.0 | 83.6 | 0.5 |

*The detergent composition for program B did contain a protease (Dermasil Protein was a component of the detergent composition) and therefore no significant difference in remission for test swatch EMPA 116 Blood, Milk, Carbon is to be expected.

The results clearly show that milder program A (significantly less non-ionic surfactants and harsh potassium hydroxide, a lower mainwash temperature, and shorter wash cycles) including a multi-enzyme composition performs equally good or significantly better than normal program B without a multi-enzyme composition. A significantly better performance was observed for swatches CFT C-S-28 Corn starch and pigment, CFT C-S-06 Salad dressing, CFT KC-H097 Cacao/Oat flakes and EMPA 165 Chocolate Pudding where improved remission values of up to 20 remission units were observed.

### Example 2

Evaluation of Wash Performance by Monitoring Rewash Rates in Field Trial Conditions

In Example 1 better wash performance when using a multi-enzyme composition was measured on standard test swatches. However,it was important to confirm the results from Example 1 by monitoring the rewash rates of real soiled items—in this example kitchen uniforms. Therefore, in a second stage of the field trial the rewash rate (defined as kitchen uniforms which after 1 wash contained stains unacceptable for the end user) was calculated for both the normal program B and the new milder program A where a multi-enzyme composition was included (i.e. the same conditions, programs, chemicals and multi-enzyme composition as in Example 1 were used).

For both wash programs A and B rewashes were counted for 5 washes/machine loads (in total 100 kitchen uniforms from each program. The kitchen uniforms were evaluated by 2 persons of the trained staff of an industrial laundry, persons who evaluate rewash/no rewash on a daily basis, in order for the industrial laundry to meet the demands of their end customers). The evaluation of the kitchen uniforms were carried out after drying and pressing the washed uniforms.

For the normal program B with only protease the rewash rate was 18% whereas the new milder program A including a multi-enzyme composition only gave a rewash rate of 10%—i,e, a reduction by 44%. Therefore the result is fully in line with the data obtained using the test swatches in Example 1. By using milder program A (significantly less non-ionic surfactants and harsh potassium hydroxide, a lower mainwash temperature, and shorter wash cycles) including a multi-enzyme composition, the rewash rate could be reduced significantly when compared with normal program B without a multi-enzyme composition.

### Example 3

Reducing Surfactants and Alkalinity in a Detergent for Industrial & Institutional Laundries and Recovering Washing Performance by Adding a Multi-Enzyme Composition.

Detergent Compositions

This example compares the washing performance of a detergent composition (I&I detergent composition), which is traditionally used for washing in industrial and institutional laundries and a detergent composition comprising a multi-enzyme composition having a reduced content of surfactant. The l&I detergent composition consisted of a surfactant solution, an alkaline solution and a bleach solution. The 3 different detergent components was added to the washing process sequentially in order to control the washing process. The detergent was used in Washer Extractors (WE), however it could also be used in Continuous Batch Washers (CBW).

The surfactant solution used in the I&I detergent composition consisted of 16% cationic surfactant, 30% non-ionic surfactants, 0.5% optical brightener, 0.65% defoamer, perfume, and color. The alkaline solution was a 10-15% aqueous solution of Sodium hydroxide. The bleach solution was a 35% aqueous solution of Hydrogen-peroxide.

The detergent composition comprising the multi-enzyme composition consisted of 10% cationic surfactant, 19% non-ionic surfactants, 0.5% optical brightener, 0.5% defoamer, 2% Glycerine, 3% Sodium tetraborate, 1.33% Esperase 8.0 L, 0.83% Termamyl 300 L, 0.83% Lipex 100 L, perfume, and color., Enzymes were produced by Novozymes NS, Bagsvaerd, Denmark.

Washing Process

The washing processes were implemented in a STAT System Washer Extractor at a commercial industrial laundry.

| | |
|---|---|
| | Detergent composition comprising |
| I&I detergent composition | multi-enzyme composition |

Load 5.6 kg laundry, 18 kg soft water

| | |
|---|---|
| Load 30 mL former surfactant | Load 30 mL new surfactant |
| solution | solution |

Agitate for 30 seconds

| | |
|---|---|
| Load 45 mL alkaline solution | Load 30 mL alkaline solution |

Agitate for 30 seconds
Load 45 mL bleach solution

| | |
|---|---|
| Heat and keep water at 60° C. | Heat and keep water at 40° C. |

Agitate for 10 minutes
Drain water
Load 30 L cold water (approximately 2° dH),
agitate for 3 minutes and drain water
Load 30 L cold water (approximately 2° dH),,
agitate for 3 minutes and drain water
Load 30 L cold water (approximately 2° dH),,
agitate for 3 minutes and drain water
Spin for 8 minutes

Washing Performance Testing

The washing performance was tested on a selection of commercial test swatches from Empa Switzerland and Center For Testmaterials BV, Vlaardingen, the Netherlands. The remission was measured after wash and line drying by a Color-Eye 7000 A (CE7000) from Gretag-macbeth (now X-rite) in reflection mode, excluding UV. D65 Daylight was used and remissions collected at 460 nm, CIE Lab.

| | | | Detergent |
|---|---|---|---|
| | | | composition |
| | | | comprising the |
| | | I&I detergent | multi-enzyme |
| Indicator for | Swatch type | composition | composition |
| General detergency | EMPA 101 Olive oil/carbon black on cotton | 40.24 | 39.64 |
| Bleaching | EMPA 114 Red wine on cotton | 45.35 | 59.51 |
| Particulate soil | EMPA 115 Immedial black on cotton | 38.38 | 40.35 |
| Whiteness | EMPA 221 White bleached cotton | 86.12 | 86.10 |
| Whiteness | EMPA 222 White unbleached cotton | 59.13 | 64.28 |
| Food stains | EMPA 111 Blood on cotton | 64.83 | 55.99 |
| Food stains | EMPA 112 Cocoa on cotton | 54.53 | 61.60 |
| Food stains | EMPA 116 Blood/milk/ink on cotton | 30.37 | 36.33 |
| Food stains | CFT CS-26 Corn starch | 37.21 | 36.62 |
| Food stains | WFK 10 EG Pre-aged egg yolk on cotton | 71.93 | 74.06 |
| Food stains | CFT C-S-10 Butterfat colored | 39.04 | 65.51 |
| Food stains | CFT C-S- 27 Potato starch on cotton | 37.05 | 36.12 |
| Food stains | CFT PC-09 Groundnut oil | 70.50 | 64.84 |
| Food stains | WFK 20 PF Vegetable fat | 70.50 | 76.19 |
| General detergency | CFT C-S-32 Sebum on cotton | 79.84 | 40.19 |
| General detergency | CFT C-S-17 Make-up on cotton | 80.11 | 80.14 |
| Bleaching | CFT B-C- 02 Coffee on cotton | 55.72 | 56.42 |
| Bleaching | WFK 10 J Tea on cotton | 62.51 | 64.21 |
| Total | | 1038.10 | 1063.65 |

Conclusion

The washing performance of the detergent composition comprising the multi-enzyme composition, when washing at 40° C., was comparable to the washing performance of the I&I detergent compostion when washing at 60° C. This opens for benefits like reduced energy consumption and COD, less wrinkling/easier ironing of the laundry, more compact detergents, less packaging materials, and less transportation of water.

### Example 4

Minimizing Fabric Tensile Strength Loss when Reducing Alkalinity and Adding a Multi-Enzyme Composition.

Detergent Composition

The same detergents as in Example 3 was used. However for the detergent composition comprising the multi-enzyme composition 1.50% Celluclean 5000 L (Novozymes NS, Bagsvaerd, Denmark) were added, so the multi-enzyme composition comprised a protease, an amylase, a lipase and the cellulase.

Washing Process

The washing processes were performed, in a European front loading household washing machine Zanussi ZWG 6120 K at 60° C. for the former detergent formulation and 40° C. for the detergent composition comprising the multi-enzyme composition. Water hardness was 140 mg CaCO₃ per Litre. Surfactant solution 20 mL, alkaline solution 20 mL, and bleach solution 15 mL per wash. Ballast load 2.4 kg.

Washing Performance Testing

The tensile strength loss was tested by multi cycle washing of WFK 11 A, Cotton with green warp threads for tests (supplied by wfk Testgewebe GmbH, Bruggen, Germany). The WFK 11 A test sheets were washes 0, 5, 10, 15, 20, or 25 cycles and tensile strength was measured using a Testometric tear tester (SDL Atlas, Rock Hill, S.C., USA) according to DIN EN ISO 13934-1 and DIN 53919 part 2 by wfk Testgewebe GmbH, Bruggen, Germany.

| | | | Loss of | |
|---|---|---|---|---|
| | Strength | | strength | Residual |
| Wash cycles | in daN* | Uncertainty | in daN | strength % |
| 0 (Unwashed) | 88 | 2 | 0 | 100 |
| I&I detergent | | | | |
| composition | | | | |
| 5 | 85 | 1 | 3 | 97 |
| 10 | 82 | 4 | 7 | 93 |
| 15 | 83 | 3 | 6 | 94 |
| 20 | 84 | 4 | 5 | 95 |
| 25 | 81 | 4 | 8 | 92 |
| Detergent composition | | | | |
| comprising the multi- | | | | |
| enzyme composition | | | | |
| 5 | 89 | 3 | −1 | 101 |
| 10 | 85 | 3 | 3 | 97 |
| 15 | 85 | 3 | 3 | 97 |
| 20 | 89 | 4 | −1 | 101 |
| 25 | 85 | 6 | 3 | 97 |

*daN = deca Newton

Conclusion

The tensile strength after 25 wash cycles with the l&I detergent composition was significantly lower than the unwashed reference swatch. The tensile strength after 25 wash cycles with the detergent composition comprising the multi-enzyme composition was still comparable to (not significant different from) the unwashed reference swatch.

The tensile strength loss with the l&I detergent composition was gradually increasing up to 8% after 25 wash cycles. The tensile strength loss with the detergent composition comprising the multi-enzyme composition was limited to 3% within the 25 wash cycles.

The detergent composition comprising the multi-enzyme composition with less alkalinity and a multi-enzyme solution consisting of protease, amylase, lipase, and cellulase, was more gentle to the cotton fabric tensile strength than the former more alkaline detergent. This indicates a longer cotton textile life time in terms of wash cycles.

### Example 5

### Reducing Rewash in an Industrial Laundry by Adding a Multi-Rnzyme Composition and Reducing Surfactants and Alkalinity in the Detergent

This example compares the washing performance of a traditional detergent composition used for washing in industrial and institutional laundries and a detergent composition comprising a multi-enzyme composition and having a reduced content of surfactants and alkali. The detergent composition consisted of a surfactant solution, an alkaline solution and a bleach solution. The 3 different detergent components were added sequentially in order to control the washing process in a Continuous Batch Washers (CBW)—an 18-chamber Voss tunnel washer.

### Detergent Compositions

The surfactant composition used in the traditional l&I detergent composition consisted of 16% cationic surfactant, 30% non-ionic surfactants, 0.5% optical brightener, 0.65% defoamer, perfume, and color. The alkaline solution was a 10-15% aqueous solution of Sodium hydroxide. The bleach solution was a 35% aqueous solution of Hydrogen-peroxide.

The new surfactant and multi-enzyme composition used instead of the traditional I&I composition in the new enzymatic wash process consisted of 10% cationic surfactant, 19% non-ionic surfactants, 0.5% optical brightener, 0.5% defoamer, 2% Glycerine, 3% Sodium tetraborate, 1.33% Esperase 8.0 L, 0.83% Termamyl 300 L, 0.83% Lipex 100 L, perfume, and color. Enzymes were produced by Novozymes NS, Bagsvaerd, Denmark. The alkaline solution was a 10-15% aqueous solution of Sodium hydroxide. The bleach solution was a 35% aqueous solution of Hydrogen-peroxide.

### Washing Process

The trial was done in an 18-chamber Voss tunnel washer loading 36 kg batches of flat-linen and set to run 120 seconds for each chamber.

| | Traditional wash program | New program |
|---|---|---|
| Chamber and Parameters | without enzymes | with enzymes |
| Wash temperature | 60° C. | 40° C. |
| Chamber 1, load: | 36 kg textiles, 160 L soft | 36 kg textiles, 160 L soft |
| | water, 200 mL traditional | water, 200 mL new enzymatic |
| | surfactant composition | surfactant composition |
| | described above, 300 mL | described above, 200 mL |
| | alkaline solution | alkaline solution |
| Chamber 1-3: | Prewash | Prewash |
| Chamber 4: | Drain | Drain |
| Chamber 4-11: | Mainwash | Mainwash |
| Chamber 9, load: | 300 mL alkaline solution, | 300 mL alkaline solution, |
| | 300 mL bleach solution | 300 mL bleach solution |
| Chamber 11, load: | Water | Water |
| | (approximately 2° dH) | (approximately 2° dH) |
| Chamber 12: | Drain | Drain |
| Chamber 12-16: | Rinse with water | Rinse with water |
| Chamber 16, load: | Water | Water |
| | (approximately 2° dH) | (approximately 2° dH) |
| Chamber 17-18: | — | — |
| Rewash rate: | 4.4% | 3.7% |

Washing performance testing The washing performance was tested monitoring rewashes over 1 month. The flat-linen was evaluated by 2 persons of the trained staff of an industrial laundry, persons who evaluate rewash/no rewash on a daily basis, in order for the industrial laundry to meet the demands of their end customers. The evaluation of the flat-linen were carried out after drying and pressing the washed flat-linen.

For the traditional wash program without enzymes the rewash rate was 4.4% whereas the new program with enzymes gave a rewash rate of 3.7%—i,e, a reduction by 16%. The new program with enzymes is not only milder (reduction of surfactants, alkali and wash temperature) the rewash rate could also be reduced significantly when compared with the traditional wash program without enzymes.

1. An industrial or institutional cleaning or laundering method for the cleaning or laundering of textiles and/or fabrics comprising the steps:
(i) placing the fabrics/textile in the washing machine;
(ii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;
(iii) optionally washing the fabrics/textile in the wash liquor;
(iv) adding a multi-enzyme composition during step (v) as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
(v) washing the fabrics/textile in the wash liquor;
(vi) optionally adding to the wash liquor one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
(vii) draining the wash liquor;
(viii) optionally repeating the wash cycle of steps (ii) to (vii) and draining the remaining wash liquor; and
(ix) rinsing and optionally drying the fabrics/textiles,
with the proviso that:
the pH of the wash liquor in step (ii) is in the range of 8-10.5 when only one wash cycle of steps (ii) to step (vii) is performed;
the pH of the wash liquor of step (ii) is in the range of 8-10.5 in at least one of the wash cycles when the wash cycle is repeated under step (viii); and
bleaching systems comprising chlorine or wash liquor comprising chlorine are not used in steps (ii) to (v) in at least one of the wash cycles when the wash cycle is repeated under step (viii).

2. An industrial or institutional cleaning or laundering method for the cleaning or laundering of textiles and/or fabrics comprising the steps:
(i) placing the fabrics/textile in the washing machine;
(ii) adding a multi-enzyme composition as a powder, granulate, liquid or slurry, optionally adding the enzymes in two or more separate compositions, or adding some enzymes together with one or more detergent components, selected from the list comprising of surfactants, hydrotropes, builders and co-builders, bleaching systems, polymers, fabric hueing agents and adjunct materials dissolved or mixed in water; and the other enzymes in one or more separate compositions;
(iii) providing a wash liquor with a pH in the range of 7-13 by dissolving/mixing one or more detergent components, selected from the list comprising of alkalis, surfactants, hydrotropes, builders and co-builders, bleaching systems, polymers, fabric hueing agents and/or adjunct materials, in water;
(iv) washing the fabrics/textile in the wash liquor;
(v) optionally adding one or more detergent components, selected from the list comprising of alkalis, surfactants, hydrotropes, builders and co-builders, bleaching systems, polymers, fabric hueing agents and adjunct materials dissolved or mixed in water and washing the fabrics/textile in the wash liquor;
(vi) draining the wash liquor;
(vii) optionally repeating the wash cycle of steps (ii) to (vi); and
(viii) rinsing and optionally drying the fabrics/textiles;
with the proviso that:
the pH of the wash liquor in step (iii) is in the range of 8-10.5 when only one wash cycle of steps (ii) to step (vi) is performed;
the pH of the wash liquor of step (iii) is in the range of 8-10.5 in at least one of the wash cycles when the wash cycle is repeated under step (viii); and
bleaching systems comprising chlorine or wash liquor comprising chlorine are not used in steps (ii) to (v) in at least one of the wash cycles when the wash cycle is repeated under step (viii).

3. The method according to claim 1, wherein each protease is independently selected from the group consisting of:
(a) a polypeptide having at least 90% sequence identity to SEQ ID NO: 1;
(b) a polypeptide having at least 90%, sequence identity to SEQ ID NO: 1 or a variant thereof wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90% sequence identity to SEQ ID NO: 2;
(d) a polypeptide having at least 90% sequence identity SEQ ID NO: 2 or a variant thereof wherein the polypeptide comprises a substitution in one or more of positions: 3, 4, 99, 101, 103, 104, 159, 194, 199, 205 and/or 217; and
(e) a polypeptide having at least 90%, sequence identity SEQ ID NO: 23;
each amylase is independently selected from the group consisting of:
(a) a polypeptide having at least 90%, sequence identity to SEQ ID NO: 3;
(b) a polypeptide having at least 90% sequence identity to SEQ ID NO: 3 or a variant thereof wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90% sequence identity to SEQ ID NO: 4
(d) a polypeptide having at least 90%, sequence identity to the hybrid polypeptide of SEQ ID NO: 5
(e) a polypeptide having at least 90% sequence identity to the hybrid polypeptide of SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90% sequence identity to SEQ ID NO: 6;
(g) a polypeptide having at least 90%, sequence identity to SEQ ID NO: 6 or a variant thereof wherein the polypeptide comprises a substitution, a deletion or an insertion in one of more of positions: 181, 182, 183, 184, 195, 206, 212, 216 and/or 269;
(h) a polypeptide having at least 90%, sequence identity to SEQ ID NO: 7, SEQ ID NO: 8 or SEQ ID NO: 9;
(i) a polypeptide having at least 90% sequence identity to SEQ ID NO: 7, SEQ ID NO: 8 or SEQ ID NO: 9 or a variant thereof wherein the polypeptide comprises a substitution, a deletion or an insertion in one of more of positions: 140, 183, 184, 195, 206, 243, 260, 304 and/or 476;
(j) a polypeptide having at least 90% sequence identity to SEQ ID NO: 10;
(k) a polypeptide having at least 90% sequence identity to SEQ ID NO: 11;
(l) a polypeptide having at least 90% sequence identity to SEQ ID NO: 11 or a variant thereof wherein the polypeptide comprises a substitution, a deletion or an insertion in one of more of positions: 176, 177, 178, 179, 190, 201, 207, 211 and/or 264;
(m) a polypeptide having at least 90% sequence identity to SEQ ID NO: 12;
(n) a polypeptide having at least 90% sequence identity to SEQ ID NO: 12 or a variant thereof wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
(o) a polypeptide having at least 90% sequence identity to SEQ ID NO: 13; and
(p) a polypeptide having at least 90% sequence identity to SEQ ID NO: 13 or a variant thereof wherein the polypeptide comprises a substitutoin, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484;
each cellulase is independently selected from the group consisting of:
(a) a polypeptide having at least 90% sequence identity to the amino acid sequence of position 1 to position 773 of SEQ ID NO:14; and
(b) a polypeptide having at least 80% sequence identity to SEQ ID NO: 15; and
(c) a polypeptide having at least 80% sequence identity to SEQ ID NO: 15 or a variant thereof wherein the polypeptide comprises a substitution, a deletion or an insertion in one or more of positions: 2, 4, 7, 8, 10, 13, 15, 19, 20, 21, 25, 26, 29, 32, 33, 34, 35, 27, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 97, 100, 101, 102, 103, 113, 114, 117, 119, 121, 133, 136, 137, 138, 139, 140, 141, 143, 145, 146, 147, 150, 151, 152, 153, 154, 155, 156, 157, 158, 159, 160, 161, 162, 164, 165, 168, 170, 171, 172, 173, 175, 176, 178, 181, 183, 184, 185, 186, 188, 191, 192, 195, 196 and/or 200;′
(d) a polypeptide having at least 80% sequence identity to SEQ ID NO: 22;
each lipase is indenpendently selected from the group consisting of:
(a) a polypeptide having at least 90% sequence identity to SEQ ID NO: 16;
(b) a polypeptide having at least 90% sequence identity to SEQ ID NO: 16 or a variant thereof wherein the polypeptide comprises a substitution, a deletion or an insertion in one of more of positions: 4, 24, 27, 33, 57, 58, 60, 62, 81, 84, 86, 87, 90, 91, 94, 96, 99, 101, 102, 147, 150, 190, 202, 209, 210, 211, 227, 231, 233, 249, 255, 256, 270, 271 and 272;
(c) a polypeptide having at least 90% sequence identity to SEQ ID NO: 16 or a variant thereof wherein the polypeptide comprises the following substitutions T231R and N233R;
each pectate lyase is independently selected from the group consisting of:
(a) a polypeptide having at least 80% sequence identity to SEQ ID NO: 17; and
(b) a polypeptide having at least 80%, sequence identity to SEQ ID NO: 17 or a variant thereof wherein the polypeptide comprises a substitution, a deletion or an insertion in one of more of positions: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and/or 397; and
each mannanase is independently selected from the group consisting of:
(a) a polypeptide having at least 80% sequence identity to amino acids 31 to 330 of SEQ ID NO: 18;
(b) a polypeptide having at least 80% sequence identity to amino acids 32 to 334 of SEQ ID NO: 19;
(c) a polypeptide having at least 80% sequence identity to amino acids 33 to 331 of SEQ ID NO: 20; and
(d) a polypeptide having at least 80% sequence identity to amino acids 68 to 369 of SEQ ID NO: 21.

4. The method according to claim 1, wherein the amount of each enzyme added per wash cycle corresponds to 0.0001-500 mg of enzyme protein per kilogram of dry textile.

5. The method according to claim 1, wherein the multi-enzyme composition gives improved cleaning benefits such as improved wash performance and/or improved enzyme detergency benefits.

6. The method according to claim 1, wherein the maximum wash temperature is reduced whilst at the same time obtaining equal or improved cleaning benefits such as improved wash performance and/or enzyme detergency benefits when compared to the method where the maximum wash temperature is not reduced and a multi-enzyme composition is not used.

7. The method according to claim 1, wherein the pH of the wash liquor is in the range of 7-10.5, in the range of 8-10.5, in the range of 8.5-9.5, in the range of 9-9.5, in the range of 9-11, in the range of 9.5-10.5, in the range of 10-11 or in the range of 10.5-11.

8. The method according to claim 1, wherein the multi-enzyme composition comprises:
a) a protease having at least 90% sequence identity to SEQ ID NO: 1;
b) an amylase having at least 90% sequence identity to SEQ ID NO: 11;
c) a polypeptide having at least 80% sequence identity to SEQ ID NO: 15;
d) a cellulase having at least 90% sequence identity to the amino acid sequence of position 1 to position 773 of SEQ ID NO:14 or a cellulase having at least 80% sequence identity to SEQ ID NO: 22;
e) a lipase having at least 90% sequence identity to SEQ ID NO: 16 or a variant thereof wherein the polypeptide comprises the following substitutions T231R and N233R;
f) a pectate lyase having at least 80% sequence identity to SEQ ID NO: 17; and
g) a mannanase having at least 80% sequence identity to amino acids 31 to 330 of SEQ ID NO: 18.

9. The method according to claim 1, wherein the multi-enzyme composition comprises:
a) a polypeptide having at least 90% sequence identity SEQ ID NO: 23;
b) a polypeptide having at least 90% sequence identity to SEQ ID NO: 16 or a variant thereof wherein the polypeptide comprises the following substitutions T231R and N233R; and
c) a polypeptide having at least 90% sequence identity to SEQ ID NO: 6;

10. The method according to claim 1, wherein 0.1 to 6.0 g of a liquid multi-enzyme composition per kg dry textile is added, wherein the multi-enzyme composition comprises:
a) a protease in a concentration affording an activity of 1.0-2.0 KNPU(S)/g, having at least 90% sequence identity to SEQ ID NO: 1;
b) an amylase in a concentration affording an activity of 0.15-0.50 SNU/g, having at least 90% sequence identity to SEQ ID NO: 11;
c) a polypeptide in a concentration affording an activity of 50-100 CNU(R)/g, having at least 80%, sequence identity to SEQ ID NO: 15;
d) a cellulase in a concentration affording an activity of 30-80 ECU/g, having at least 90% sequence identity to the amino acid sequence of position 1 to position 773 of SEQ ID NO:22;
e) a lipase in a concentration affording an activity of 2.0-4.0 KLU/g, having at least 90% sequence identity to SEQ ID NO: 16 or a variant thereof wherein the polypeptide comprises the following substitutions T231R and N233R;
f) a pectate lyase in a concentration affording an activity of 9.0-16.0 PDEU/g, having at least 80% sequence identity to SEQ ID NO: 17; and
g) a mannanase in a concentration affording an activity of 0.025-0.075 MIU/g, having at least 80% sequence identity to amino acids 31 to 330 of SEQ ID NO: 18.

11. The method according to claim 1, wherein a washing step is carried out between step (i) and step (ii), wherein the pH of the wash liquor is in the range of 8-13, such as 10-13.

12.-15. (canceled)


SEQUENCE LISTING (23 sequences)

SEQ ID NO: 1 - protein, 269 aa, Bacillus  lentus (subtilisin 309)
  MISC_FEATURE: corresponding to SEQ ID NO 4 of WO2003/006602
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus Lentus ATCC 53926
  MISC_FEATURE: corresponding to the amino acid sequence shown in figure 29 of US 5,352,604
AQTVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 3 - DNA, 2084 bp, Bacillus amyloliquefaciens
  misc_feature: corresponding to SEQ ID NO 3 of WO1995/010603
gccccgcacatacgaaaagactggctgaaaacattgagcctttgatgactgatgatttggctgaagaagtggatcgattgtttgagaaaagaagaagaccataaaaataccttgtctgtcatcagacagggtattttttatgctgtccagactgtccgctgtgtaaaaataaggaataaaggggggttgttattattttactgatatgtaaaatataatttgtataagaaaatgagagggagaggaaacatgattcaaaaacgaaagcggacagtttcgttcagacttgtgcttatgtgcacgctgttatttgtcagtttgccgattacaaaaacatcagccgtaaatggcacgctgatgcagtattttgaatggtatacgccgaacgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaatcagagcttcaagatgcgatcggctcactgcattcccggaacgtccaagtatacggagatgtggttttgaatcataaggctggtgctgatgcaacagaagatgtaactgccgtcgaagtcaatccggccaatagaaatcaggaaacttcggaggaatatcaaatcaaagcgtggacggattttcgttttccgggccgtggaaacacgtacagtgattttaaatggcattggtatcatttcgacggagcggactgggatgaatcccggaagatcagccgcatctttaagtttcgtggggaaggaaaagcgtgggattgggaagtatcaagtgaaaacggcaactatgactatttaatgtatgctgatgttgactacgaccaccctgatgtcgtggcagagacaaaaaaatggggtatctggtatgcgaatgaactgtcattagacggcttccgtattgatgccgccaaacatattaaattttcatttctgcgtgattgggttcaggcggtcagacaggcgacgggaaaagaaatgtttacggttgcggagtattggcagaataatgccgggaaactcgaaaactacttgaataaaacaagctttaatcaatccgtgtttgatgttccgcttcatttcaatttacaggcggcttcctcacaaggaggcggatatgatatgaggcgtttgctggacggtaccgttgtgtccaggcatccggaaaaggcggttacatttgttgaaaatcatgacacacagccgggacagtcattggaatcgacagtccaaacttggtttaaaccgcttgcatacgcctttattttgacaagagaatccggttatcctcaggtgttctatggggatatgtacgggacaaaagggacatcgccaaaggaaattccctcactgaaagataatatagagccgattttaaaagcgcgtaaggagtacgcatacgggccccagcacgattatattgaccacccggatgtgatcggatggacgagggaaggtgacagctccgccgccaaatcaggtttggccgctttaatcacggacggacccggcggatcaaagcggatgtatgccggcctgaaaaatgccggcgagacatggtatgacataacgggcaaccgttcagatactgtaaaaatcggatctgacggctggggagagtttcatgtaaacgatgggtccgtctccatttatgttcagaaataaggtaataaaaaaacacctccaagctgagtgcgggtatcagcttggaggtgcgtttattttttcagccgtatgacaaggtcggcatcaggtgtgacaaatacggtatgctggctgtcataggtgacaaatccgggttttgcgccgtttggctttttcacatgtctgatttttgtataatcaacaggcacggagccggaatctttcgccttggaaaaataagcggcgatcgtagctgcttccaatatggattgttcatcgggatcgctgcttttaatcacaacgtgggatcc

SEQ ID NO: 4 - protein, 515 aa, Bacillus stearothermophilus
  MISC_FEATURE: corresponding to SEQ ID NO 6 in WO 2002/010355
AAPFNGTMMQYFEWYLPDDGTLWTKVANEANNLSSLGITALWLPPAYKGTSRSDVGYGVYDLYDLGEFNQKGTVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGIGKAWDWEVDTENGNYDYLMYADLDMDHPEVVTELKNWGKWYVNTTNIDGFRLDAVKHIKFSFFPDWLSYVRSQTGKPLFTVGEYWSYDINKLHNYITKTDGTMSLFDAPLHNKFYTASKSGGAFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGGTEKPGSGLAALITDGPGGSKWMYVGKQHAGKVFYDLTGNRSDTVTINSDGWGEFKVNGGSVSVWVPRKTTVSTIARPITTRPWTGEFVRWTEPRLVAWP

SEQ ID NO: 5 - protein, 481 aa, Artificial Sequence
  Residues 1-33 of SEQ ID NO 6 of WO 2006/066594 and residues 36-483 of SEQ ID NO 4 of WO 2006/066594
VNGTLMQYFEWYTPNDGQHWKRLQNDAEHLSDIGITAVWIPPAYKGTSQADVGYGAYDLYDLGEFHQKGTVRTKYGTKGELQSAIKSLHSRDINVYGDVVINHKGGADATEDVTAVEVDPADRNRVISGEHLIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNGTVVSKHPLKSVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 6 - protein, 485 aa, Bacillus sp.
  MISC_FEATURE: corresponding to SEQ ID NO 6 of WO 2002/019467
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK

SEQ ID NO: 7 - protein, 485 aa, Bacillus sp. NCIB 12512
  MISC_FEATURE: corresponding to SEQ ID NO 1 of WO 1996/023873
HHNGTNGTMMQYFEWYLPNDGNHWNRLRDDAANLKSKGITAVWIPPAWKGTSQNDVGYGAYDLYDLGEFNQKGTVRTKYGTRNQLQAAVTSLKNNGIQVYGDVVMNHKGGADGTEIVNAVEVNRSNRNQETSGEYAIEAWTKFDFPGRGNNHSSFKWRWYHFDGTDWDQSRQLQNKIYKFRGTGKAWDWEVDTENGNYDYLMYADVDMDHPEVIHELRNWGVWYTNTLNLDGFRIDAVKHIKYSFTRDWLTHVRNTTGKPMFAVAEFWKNDLGAIENYLNKTSWNHSVFDVPLHYNLYNASNSGGYYDMRNILNGSVVQKHPTHAVTFVDNHDSQPGEALESFVQQWFKPLAYALVLTREQGYPSVFYGDYYGIPTHGVPAMKSKIDPLLQARQTFAYGTQHDYFDHHDIIGWTREGNSSHPNSGLATIMSDGPGGNKWMYVGKNKAGQVWRDITGNRTGTVTINADGWGNFSVNGGSVSVWVKQ

SEQ ID NO: 8 - protein, 485 aa, Bacillus sp. NCIB 12513
  MISC_FEATURE: corresponding to SEQ ID NO 2 of WO 1996/023873
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 9 - protein, 485 aa, Bacillus sp. #707; identical to SEQ ID NO: 6
  MISC_FEATURE: corresponding to SEQ ID NO 7 of WO 1996/023873

SEQ ID NO: 10 - protein, 485 aa, Bacillus sp. A 7-7 (DSM 12368)
  MISC_FEATURE: corresponding to SEQ ID NO 2 of WO 2008/153815
HHNGTNGTMMQYFEWYLPNDGNHWNRLRSDASNLKDKGITAVWIPPAWKGASQNDVGYGAYDLYDLGEFNQKGTVRTKYGTRNQLQAAVTALKSNGIQVYGDVVMNHKGGADATEWVRAVEVNPSNRNQEVSGDYTIEAWTKFDFPGRGNTHSNFKWRWYHFDGVDWDQSRQLQNRIYKFRGDGKGWDWEVDTENGNYDYLMYADIDMDHPEVVNELRNWGVWYTNTLGLDGFRIDAVKHIKYSFTRDWLTHVRNTTGKNMFAVAEFWKNDIGAIENYLSKTNWNHSVFDVPLHYNLYNASRSGGNYDMRQIFNGTVVQRHPTHAVTFVDNHDSQPEEALESFVEEWFKPLAYALTLTRDQGYPSVFYGDYYGIPTHGVPAMKSKIDPILEARQKYAYGKQNDYLDHHNMIGWTREGNTAHPNSGLATIMSDGPGGNKWMYVGRNKAGQVWRDITGNRSGTVTINADGWGNFSVNGGSVSIWVNN

SEQ ID NO: 11 - protein, 483 aa, Bacillus amyloliquefaciens
  MISC_FEATURE: corresponding to SEQ ID NO 10 of WO 2001/066712
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 12 - protein, 484 aa, Bacillus sp. TS-23
  MISC_FEATURE: corresponding to SEQ ID NO 2 of WO 2009/061380
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK

SEQ ID NO: 13 - protein, 485 aa, Bacillus sp.
  MISC_FEATURE: corresponding to SEQ ID NO 12 of WO 2001/066712
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 14 - protein, 773 aa, Bacillus sp.
  MISC_FEATURE: corresponding to the amino acid sequence of position 1 to position 773 of SEQ ID NO2 in WO2002/099091
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 15 - protein, 200 aa, Thielavia terrestris
  MISC_FEATURE: corresponding to SEQ ID NO 5 of WO1998/012307
GSGQSTRYWDCCKPSCAWPGKAAVSQPVYACDANFQRLSDFNVQSGCNGGSAYSCADQTPWAVNDNLAYGFAATSIAGGSESSWCCACYALTFTSGPVAGKTMVVQSTSTGGDLGSNQFDIAMPGGGVGIFNGCSSQFGGLPGAQYGGISSRDQCDSFPAPLKPGCQWRFDWFQNADNPTFTFQQVQCPAEIVARSGCKR

SEQ ID NO: 16 - protein, 269 aa, Thermomyces lanuginosus [sequence omitted]

SEQ ID NO: 17 - protein, 399 aa, Bacillus subtilis [sequence omitted]

SEQ ID NO: 18 - protein, 490 aa, Bacillus sp. I633
  MISC_FEATURE: corresponding to SEQ ID NO 2 of WO 1999/064619
LNNGFKKIFSITLSLLLASSILFVSGTSTANANSGFYVSGTTLYDANGNPFVMRGINHGHAWYKDQATTAIEGIANTGANTVRIVLSDGGQWTKDDIHTVRNLISLAEDNHLVAVPEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFTGGGSDGGTSPTTLYDFEGSMQGWTGSSLSGGPWAVTEWSSKGSHSLKADIQLSSNSQHYLHVIQNTSLQQNSRIQATVKHANWGSVGNGMTARLYVKTGHGYTWYSGSFVPINGSSGTTLSLDLSNVQNLSQVREIGVQFQSASDSSGQTSIYIDNVIVE

SEQ ID NO: 19 - protein, 493 aa, Bacillus agaradhaerens
  MISC_FEATURE: corresponding to SEQ ID NO 6 of WO 1999/064619
MKKKLSQIYHLIICTLIISVGIMGITTSPSAASTGFYVDGNTLYDANGQPFVMRGINHGHAWYKDTASTAIPAIAEQGANTIRIVLSDGGQWEKDDIDTIREVIELAEQNKMVAVVEVHDATGRDSRSDLNRAVDYWIEMKDALIGKEDTVIINIANEWYGSWDGSAWADGYIDVIPKLRDAGLTHTLMVDAAGWGQYPQSIHDYGQDVFNADPLKNTMFSIHMYEYAGGDANTVRSNIDRVIDQDLALVIGEFGHRHTDGDVDEDTILSYSEETGTGWLAWSWKGNSTEWDYLDLSEDWAGQHLTDWGNRIVHGADGLQETSKPSTVFTDDNGGHPEPPTATTLYDFEGSTQGWHGSNVTGGPWSVTEWGASGNYSLKADVNLTSNSSHELYSEQSRNLHGYSQLNATVRHANWGNPGNGMNARLYVKTGSDYTWHSGPFTRINSSNSGTTLSFDLNNIENSHHVREIGVQFSAADNSSGQTALYVDNVTLR

SEQ ID NO: 20 - protein, 331 aa, Bacillus sp. AAI12
  MISC_FEATURE: corresponding to SEQ ID NO 12 of WO 1999/064619
VYKLTHTYFVALICSILIFAGVLNTSSSQAEAHHSGFHVNGTTLYDANGNPFVMRGINHGHAWFKQELETSMRGISQTGANTIRVVLSNGQRWQKDDRNMVASVISLAEQHQMIAVLEVHDATGSNNFSDLQAAVDYWIEMKDVLQGKEDIVIINIANEWYGAWDGGAWARGYQNAIRQLRNAGLSHTFMVDAAGYGQYPQSVVDYGQEVLNADPQRNTMFSVHMYEYAGGDANTVRRNIDSILSQNLALVIGEFGHWHYDGDVDEDTILSYSQQRNVGWLAWSWHGNSEGVEYLDLSNDFAGNRLTWWGDRIVNGPNGIRQTSKRSSVFQ

SEQ ID NO: 21 - protein, 369 aa, Bacillus sp. AA349
  MISC_FEATURE: corresponding to SEQ ID NO 16 of WO 1999/064619
MRSMKLLFAMFILVFSSFTFNLVVAQASGHGQMHKVPWAPQAEAPGKTAENGVWDKVRNNPGKANPPAGKVNGFYIDGTTLYDANGKPFVMRGINHGHSWYKPHIETAMEAIADTGANSIRVVLSDGQQWTKDDVDEVAKIISLAEKHSLVAALEVHDALGTDDIEPLLKTVDYWIEIKDALIGKEDKVIINISNEWFGSWSSEGWADGYKKAIPLLREAGLKHTLMVDAAGWGQFPRSIHEKGLEVFNSDPLKNTMFSIHMYEWAAGNPQQVKDNIDGVLEKNLAVVIGEFGHHHYGRDVAVDTILSHSEKYDVGWLAWSWHGNSGGVEYLDLATDFSGTQLTEWGERIVHGPNGLKETSEIVSVYKK

SEQ ID NO: 22 - protein, 435 aa, Humicola insolens
  SIGNAL (1)..(20)
  mat_peptide (21)..(415)
MARGTALLGLTALLLGLVNGQKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD

SEQ ID NO: 23 - protein, 35 aa, Bacillus halodurans
YTNNQIRQRINQTATYLGSPSLYGNGLVHAGRATQ